(19) United States
(12) Patent Application Publication
(10) Pub. No.: US 2018/0075568 A1
(43) Pub. Date: Mar. 15, 2018

(54) ORDER PROCESSING METHOD, APPARATUS AND SYSTEM

(71) Applicant: BOE TECHNOLOGY GROUP CO., LTD., Beijing (CN)

(72) Inventors: Junjie ZHAO, Beijing (CN); Junyuan REN, Beijing (CN)

(21) Appl. No.: 15/680,562

(22) Filed: Aug. 18, 2017

(30) Foreign Application Priority Data
Sep. 14, 2016 (CN) 201610825189.7

(51) Int. Cl. G06Q 50/30; G06Q 30/06

(52) U.S. Cl. CPC G06Q 50/30; H04L 67/12; G06Q 30/0635

(57) ABSTRACT

The present disclosure relates to an order processing method, an apparatus and a system, which belongs to the field of information technology. The method is used in a taxi server and the method includes: receiving a first order request sent from a user terminal, the first order request including ordering information, the ordering information at least including n destination addresses, n≧2 and the n being an integer; processing the first order request according to the n destination addresses, to obtain a second order request; and sending the second order request to a vehicle-mounted terminal.

### CROSS-REFERENCES TO RELATED APPLICATIONS

This application claims priority to Chinese Patent Application No. 201610825189.7 filed in China on Sep. 14, 2016, the entire contents of which are hereby incorporated by reference.

### TECHNICAL FIELD

The present disclosure relates to the field of information technology and, more particularly, to an order processing method, apparatus and system.

### BACKGROUND

With the rapid development of Internet and mobile devices, especially the popularity of smart phones and intelligent mobile navigation systems, it brings great convenience for travel of people. With the urban development, hailing a taxi is already a common demand of people. With the harmonious combination of Internet and taxi industry, a taxi platform including a taxi client and a taxi server emerges at the right moment. The order processing method based on the taxi platform improves the efficiency of hailing the taxi and facilitates travel of people.

It should be noted that, information disclosed in the above background portion is provided only for better understanding of the background of the present disclosure, and thus it may contain information that does not form the prior art known by those ordinary skilled in the art.

### SUMMARY

The present disclosure provides an order processing method, apparatus and system. The technical scheme is as follows.

In a first aspect, there is provided an order processing method, including:

receiving a first order request, the first order request including ordering information, the ordering information at least including n destination addresses, n≧2 and the n being an integer;

processing the first order request according to the n destination addresses, to obtain a second order request; and

sending the second order request to a vehicle-mounted terminal.

In another aspect, there is provided an order processing apparatus, including:

a processor; and

a memory, for storing instructions executable by the processor,

wherein the processor is configured to:

receive a first order request, the first order request including ordering information, the ordering information at least including n destination addresses, n≧2 and the n being an integer;

process the first order request according to then destination addresses, to obtain a second order request; and

send the second order request to a vehicle-mounted terminal.

An order processing system, includes: a server, a user terminal and a vehicle-mounted terminal,

wherein the server is configured to: receive a first order request, the first order request including ordering information, the ordering information at least including n destination addresses, n≧2 and the n being an integer; process the first order request according to the n destination addresses, to obtain a second order request; and send the second order request to a vehicle-mounted terminal;

the user terminal is configured to: acquire a first order request, the first order request including ordering information, the ordering information at least including n destination addresses, n≧2 and the n being an integer; and

send the first order request to a taxi server, such that the taxi server processes the first order request according to the n destination addresses to obtain a second order request and sends the second order request to the vehicle-mounted terminal.

It is to be understood that both the foregoing general description and the following detailed description are exemplary and explanatory only and are not restrictive of the invention, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

In order to clarify the technical scheme of the embodiment of the present disclosure, the following drawings, which are intended to be used in the description of the embodiments, will be briefly described. It will be apparent that the drawings in the following description are merely some embodiments of the present disclosure. Other drawings may be obtained by those skilled in the art based on these drawings without paying for creative labor.

FIG. 1 is a schematic view of an implementation environment involved by various embodiments provided by an embodiment of the present disclosure;

FIG. 2 is a flow chart of an order processing method provided by an embodiment of the present disclosure;

FIG. 3 is another flow chart of an order processing method provided by an embodiment of the present disclosure;

FIG. 4 is yet another flow chart of an order processing method provided by an embodiment of the present disclosure;

FIG. 5-1 is still another flow chart of an order processing method provided by an embodiment of the present disclosure;

FIG. 5-2 is a flow chart of a user terminal acquiring a first order request provided by an embodiment of the present disclosure;

FIG. 5-3 is a schematic diagram of an ordering page provided by an embodiment of the present disclosure;

FIG. 5-4 is a schematic diagram of a route map provided by an embodiment of the present disclosure;

FIG. 5-5 is a flow chart of a taxi server sending a sub-order request provided by an embodiment of the present disclosure;

FIG. 5-6 is a schematic diagram of a taxi server interacting with vehicle-mounted terminals Z1 and Z2 respectively provided by an embodiment of the present disclosure;

FIG. 6-1 is still another flow chart of an order processing method provided by an embodiment of the present disclosure;

FIG. 6-2 is yet another schematic diagram of a route map provided by an embodiment of the present disclosure;

FIG. 7-1 is still another flow chart of an order processing method provided by an embodiment of the present disclosure;

FIG. 7-2 is a flow chart of an order processing method provided by an embodiment of the present disclosure;

FIG. 8-1 is a block diagram of a vehicle booking apparatus provided by an embodiment of the present disclosure;

FIG. 8-2 is a block diagram of a processing module provided by an embodiment of the present disclosure;

FIG. 8-3 is a block diagram of a first sending module provided by an embodiment of the present disclosure;

FIG. 8-4 is a block diagram of a vehicle booking apparatus provided by an embodiment of the present disclosure;

FIG. 9-1 is still another block diagram of a vehicle booking apparatus provided by an embodiment of the present disclosure;

FIG. 9-2 is a block diagram of a vehicle booking apparatus provided by an embodiment of the present disclosure;

FIG. 9-3 is a block diagram of a vehicle booking apparatus provided by an embodiment of the present disclosure;

FIG. 10-1 is a block diagram of a vehicle booking apparatus provided by an embodiment of the present disclosure; and

FIG. 10-2 is a block diagram of a vehicle booking apparatus provided by an embodiment of the present disclosure.

### DETAILED DESCRIPTION

The implementation of the present disclosure will be described in further detail with reference to the accompanying drawings, such that the objects, technical schemes, and advantages of the present disclosure will become more apparent.

In a comparison embodiment, there is an order processing method by which a user hails a taxi through a taxi client in a terminal (i.e., a user terminal) carried by himself/herself. Specifically, the user terminal sends an order request to the taxi server for booking a vehicle through the taxi client. The order request includes ordering information, and the ordering information includes a start address and a destination address input from a user and information of the user (including the name and telephone number of the user). Then, the taxi server sends the order request to a plurality of terminals of vehicles (i.e., vehicle-mounted terminals) within a certain range. After the plurality of vehicle-mounted terminals receive the order request, the taxi server designates one from the plurality of vehicle-mounted terminals to serve the user. Alternatively, the taxi server directly sends the order request to one vehicle-mounted terminal, to make the vehicle-mounted terminal serve the user.

The above method is only applicable to the case where one destination address is included in the ordering information, which is not applicable to the case where a plurality of destination addresses are included in the ordering information. Therefore, the above order processing method has low reliability of booking a vehicle.

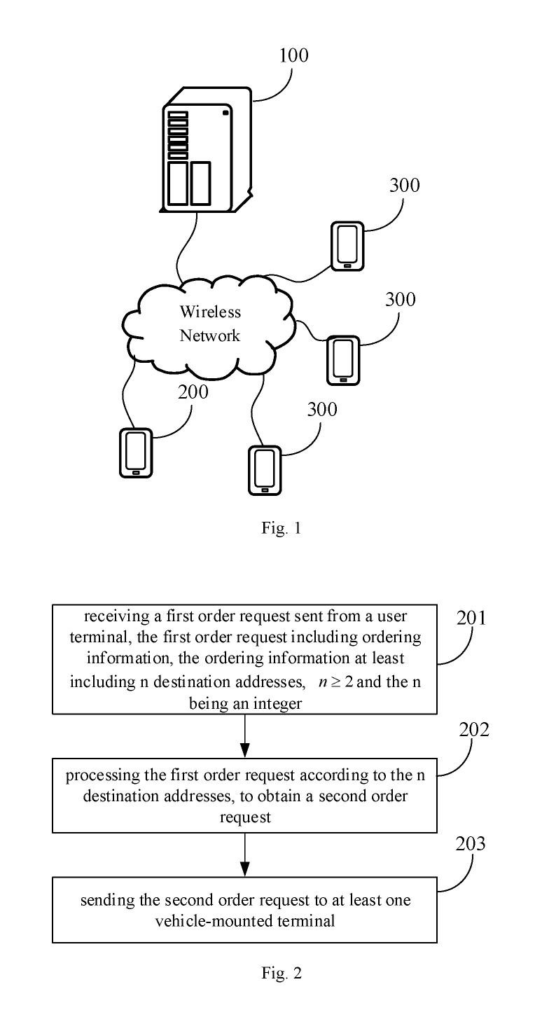

FIG. 1 shows a schematic view of an implementation environment involved by various embodiments of the present disclosure. The implementation environment may include a taxi server 100, a user terminal 200 and a plurality of vehicle-mounted terminals 300.

The taxi server 100 may be a server, or a server cluster consisting of several servers, or a cloud computing service center. The taxi server 100 establishes a connection with the user terminal 200 and the vehicle-mounted terminal 300 via a wireless network, respectively.

The user terminal 200 may be a wearable device, a mobile phone, a tablet computer, a computer, or the like.

The vehicle-mounted terminal 300 may be a wearable device, a mobile phone, a tablet computer, a computer, or the like, and the present implementation environment does not limit the number of the vehicle-mounted terminal 300.

After receiving a first order request sent from the user terminal 200, the taxi server 100 may process the first order request based on the plurality of destination addresses in ordering information included in the first order request, to obtain a second order request, and send the second order request to at least one vehicle-mounted terminal 300.

FIG. 2 is a flow chart of an order processing method according to an exemplary embodiment. In the embodiment, for example, the order processing method is applied to the taxi server 100 in the implementation environment as shown in FIG. 1. The order processing method may include following steps.

In step 201, a first order request sent from a user terminal is received, the first order request including ordering information, the ordering information at least including n destination addresses, n≧2 and the n being an integer.

In step 202, the first order request is processed according to the n destination addresses, to obtain a second order request.

In step 203, the second order request is sent to at least one vehicle-mounted terminal.

In view of above, in the order processing method provided by the embodiment of the present disclosure, a taxi server may receive a first order request sent from a user terminal, and process the first order request to obtain a second order request, and then send the second order request to at least one vehicle-mounted terminal. In the embodiment, the first order request includes ordering information, and the ordering information includes a plurality of destination addresses. Compared with the comparison embodiment, the method is applicable to the case where the ordering information includes a plurality of destination addresses. Through the method, the user may still book a vehicle successfully even when inputting a plurality of destination addresses, thus improving the reliability of booking a vehicle.

Further, on one hand, step 202 may include:

judging whether the first order request needs to be divided according to the ordering information; and when the first order request needs to be divided, dividing the first order request into m sub-order requests according to the ordering information, 2≦m≦n and the m being an integer; and taking the m sub-order requests as the second order request.

Correspondingly, step 203 may include: sending the m sub-order requests to at least m different vehicle-mounted terminals respectively.

On the other hand, the ordering information further includes an address type identification and a start address. The address type identification is used to indicate that the n destination addresses are n serial destination addresses that a user expects to reach successively.

Step 202 may include:

judging whether n+1 addresses consisting of the start address and the n destination addresses meet a second preset condition;

when the n+1 addresses meet the second preset condition, adjusting an order of the n serial destination addresses and obtaining the second order request,

wherein the second preset condition is:

S₁>S₃;

or, T₁>T₃;

or, S₁>S₃ and T₁>T₃;

wherein the S₁ is a sum of driving distances of adjacent two addresses of the n+1 addresses, the S₃ is a sum of driving distances of adjacent two addresses of the n+1 addresses whose order has been adjusted, the T₁ is a sum of driving times of adjacent two addresses of the n+1 addresses, and the T₃ is a sum of driving times of adjacent two addresses of the n+1 addresses whose order has been adjusted.

In view of above, in the order processing method provided by the embodiment of the present disclosure, a taxi server may receive a first order request sent from a user terminal, and process the first order request to obtain a second order request, and then send the second order request to at least one vehicle-mounted terminal. In the embodiment, the first order request includes ordering information, and the ordering information includes a plurality of destination addresses. Compared with the comparison embodiment, the method is applicable to the case where the ordering information includes a plurality of destination addresses. Through the method, the user may still book a vehicle successfully even when inputting a plurality of destination addresses, thus improving the reliability of booking a vehicle.

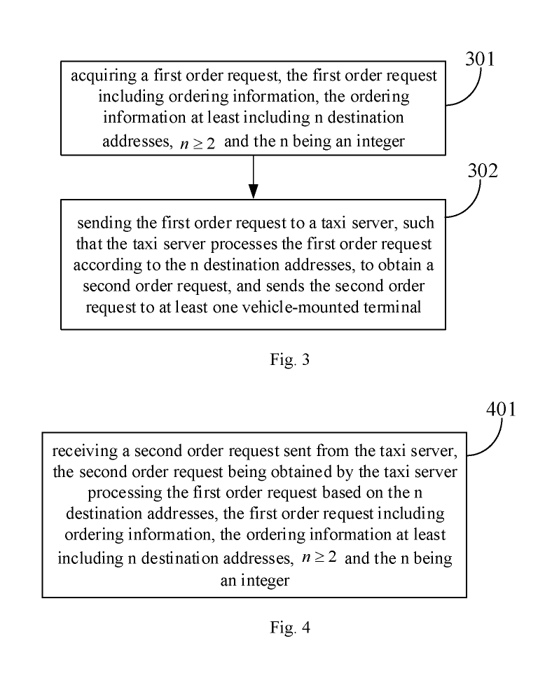

FIG. 3 is a flow chart of an order processing method according to an exemplary embodiment. In the embodiment, for example, the order processing method is applied to the user terminal 200 in the implementation environment as shown in FIG. 1. The order processing method may include following steps.

In step 301, a first order request is acquired, the first order request including ordering information, the ordering information at least including n destination addresses, n≧2 and the n being an integer.

In step 302, the first order request is sent to a taxi server, such that the taxi server processes the first order request according to the n destination addresses, to obtain a second order request, and sends the second order request to at least one vehicle-mounted terminal.

In view of above, in the order processing method provided by the embodiment of the present disclosure, a user terminal may send a first order request to a taxi server, such that the taxi server may process the first order request according to the plurality of destination addresses of the ordering information included in the first order request, to obtain a second order request, and send the second order request to at least one vehicle-mounted terminal. Compared with the comparison embodiment, the method is applicable to the case where the ordering information includes a plurality of destination addresses. Through the method, the user may still book a vehicle successfully even when inputting a plurality of destination addresses, thus improving the reliability of booking a vehicle.

FIG. 4 is a flow chart of an order processing method according to an exemplary embodiment. In the embodiment, for example, the order processing method is applied to the vehicle-mounted terminal 300 in the implementation environment as shown in FIG. 1. The order processing method may include following steps.

In step 401, a second order request sent from the taxi server is received. The second order request is obtained by the taxi server processing the first order request based on the n destination addresses. The first order request includes ordering information, the ordering information at least including n destination addresses, n≧2 and the n being an integer.

In view of above, in the order processing method provided by the embodiment of the present disclosure, a vehicle-mounted terminal may receive a second order request sent from the taxi server. The second order request is obtained by the taxi server processing the first order request based on the plurality of destination addresses of the ordering information included in the first order request. Compared with the comparison embodiment, the method is applicable to the case where the ordering information includes a plurality of destination addresses. Through the method, the user may still book a vehicle successfully even when inputting a plurality of destination addresses, thus improving the reliability of booking a vehicle.

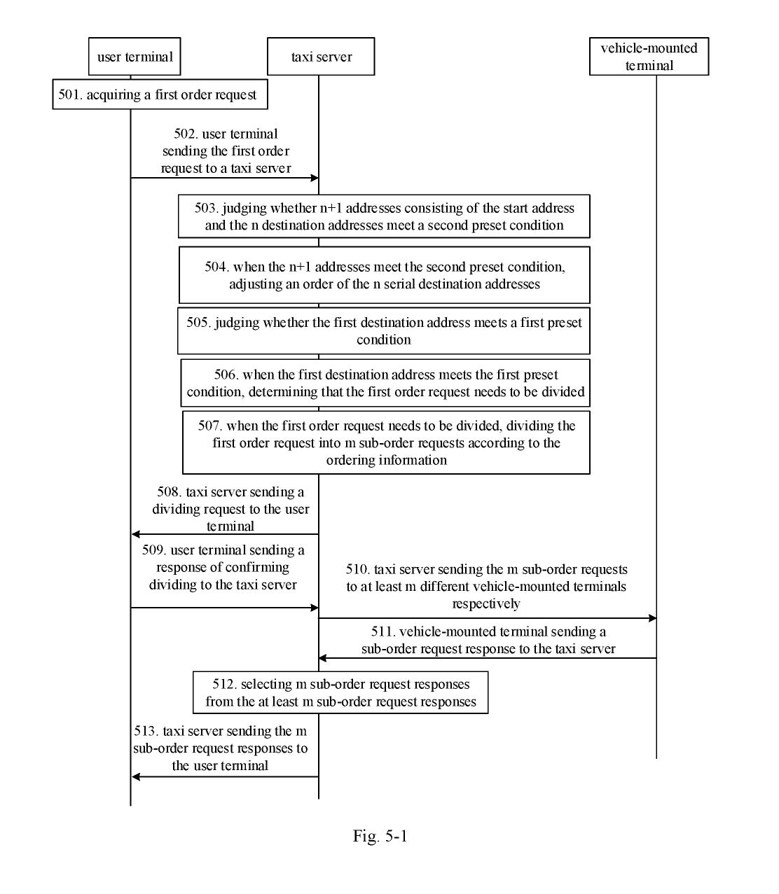

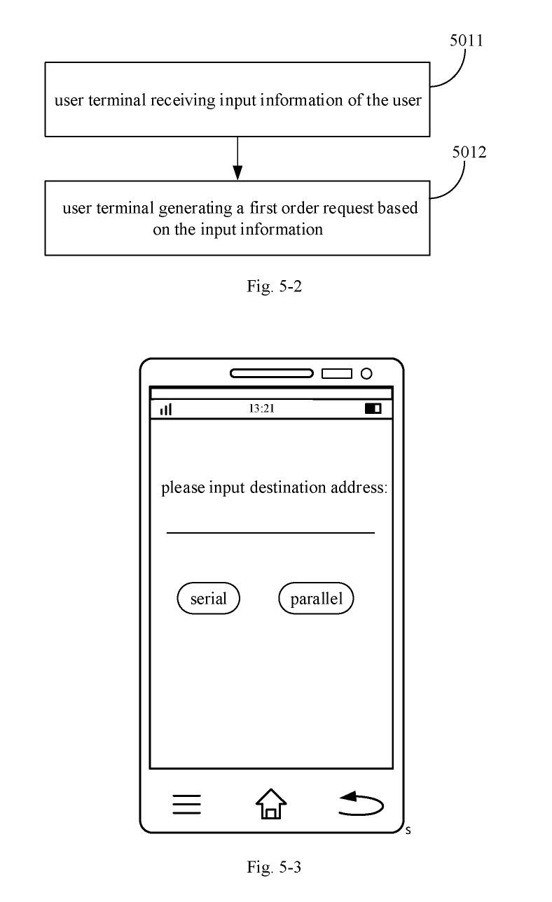

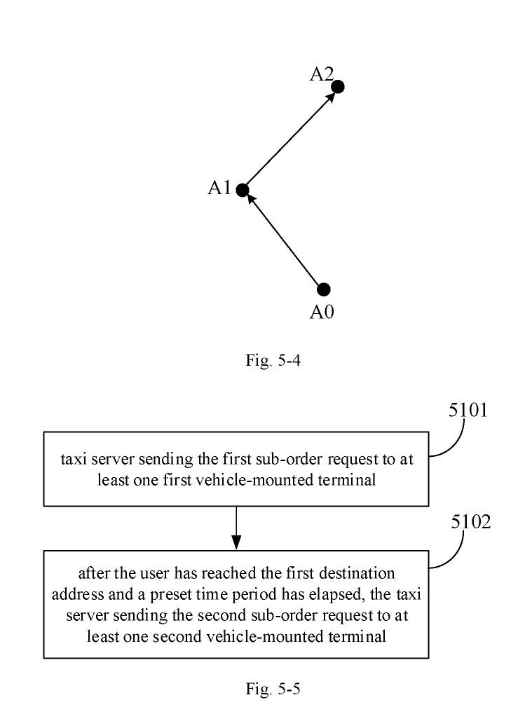

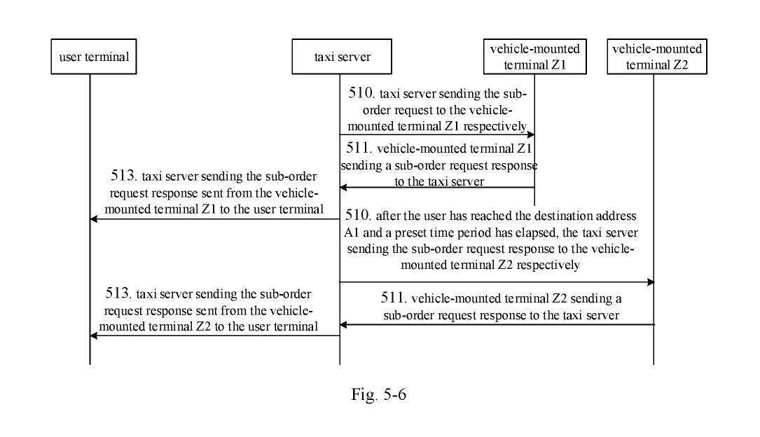

FIG. 5-1 is a flow chart of an order processing method according to an exemplary embodiment. In the embodiment, for example, the order processing method is applied to the implementation environment as shown in FIG. 1. The order processing method may include following steps.

In step 501, a user terminal acquires a first order request.

The first order request includes ordering information, the ordering information at least including n destination addresses, n≧2 and the n being an integer.

Specifically, as shown in FIG. 5-2, step 501 may include following steps.

In step 5011, the user terminal receives input information of the user.

The input information includes n destination addresses. For example, an input manner may be any of a voice input manner, a text input manner and a graphic input manner.

Assuming that the user YH is currently in an address A0 (i.e., the start address), if the user YH wants to go to a destination address A1 firstly and then go to a destination address A2, for example, as shown in FIG. 5-3, an ordering page (i.e., an ordering interface) of the user terminal may display two options: “serial” and “parallel”. The user YH may input the two destination addresses A1 and A2 via the ordering page of the user terminal and then select the “serial” option. In order to facilitate the user to learn about the serial destination address and parallel destination address, the two options may be provided with a link respectively. When the user clicks an identification of the link of the options, the user may obtain introduction of the serial destination address or the parallel destination address.

In addition, the ordering page of the user terminal may also display two tables. One table is used to input a plurality of serial destination address, which may be as shown in Table 1. The other table is used to input a plurality of parallel destination address, which may be as shown in Table 2. When the user YH inputs two destination addresses A1 and A2 in Table 1, the user terminal may determine that the two destination addresses A1 and A2 are two serial destination addresses that the user expects to reach successively. When the user YH inputs two destination addresses A1 and A2 in Table 2, the user terminal may determine that the two destination addresses A1 and A2 are two parallel destination addresses that the user expects to reach.

TABLE 1
Destination address
A1
A2

TABLE 2

| | | |
|---|---|---|
| Destination address | A1 | A2 |

In addition, the user YH may draw a route map on the ordering page of the user terminal. As shown in FIG. 5-4, the user terminal may determine that the two destination addresses A1 and A2 are two serial destination addresses that the user expects to reach successively, according to endpoint names, the number of endpoints and indicating arrows on the lines in the route map.

In step 5012, the user terminal generates a first order request based on the input information.

Taking the destination addresses A1 and A2 in step 5011 as an example, the user terminal generates the first order request based on the input information. The first order request includes ordering information, and the ordering information includes two destination addresses A1 and A2. Further, when the user selects the “serial” option, or when the user inputs two destination addresses in Table 1, the ordering information may include an address type identification indicating that the two destination addresses A1 and A2 are two serial destination addresses that the user expects to reach successively.

In addition, the ordering information further includes a start address and user information. The user information includes a telecommunication number of a target user. For example, the target user may be the user YH. Optionally, the telecommunication number of the target user is a telephone number of the target user.

In addition, it is to be noted that the telecommunication number of the target user may be represented directly by the telephone number of the target user, or may be represented by a part of the telephone number, or may also be represented by any number identification which can uniquely indicate the telephone number. The embodiment of the present disclosure is not limited thereto. In addition, the user information may further include the identification of the target user. Optionally, the identification of the target user may be the name of the target user, the family name of the target user, or the given name of the target user.

In step 502, the user terminal sends the first order request to a taxi server.

The ordering information further includes a stay time of the user being at a first destination address. The first destination address is any one of the n destination addresses except for a last destination address.

After the taxi server receives the first order request sent from the user terminal, since the ordering information includes the address type identification being used to indicate that the n destination addresses are n serial destination addresses that the user expects to reach successively, the taxi server may determine that the n destination addresses are n serial destination addresses based on the address type identification. For example, the address type identification may be represented by a number. For example, when the address type identification is 1, it represents that then destination addresses are n serial destination addresses that a user expects to reach successively. When the address type identification is 0, it represents that the n destination addresses are n parallel destination addresses that a user expects to reach.

Taking the user YH as an example, the ordering information of the first order request sent by the user terminal to the taxi server may include: the start address A0, two destination addresses A1 and A2, the name of the user YH, the telephone number of the user YH, and a stay time T′(A1A2) of the user YH being in A1. The ordering information also includes the address type identification of 1.

In step 503, the taxi server judges whether n+1 addresses consisting of the start address and the n destination addresses meet a second preset condition.

The second preset condition is:

S₁>S₃;

or, T₁>T₃;

or, S₁>S₃ and T₁>T₃;

wherein the S₁ is a sum of driving distances of adjacent two addresses of the n+1 addresses, the S₃ is a sum of driving distances of adjacent two addresses of the n+1 addresses whose order has been adjusted, the T₁ is a sum of driving times of adjacent two addresses of the n+1 addresses, and the T₃ is a sum of driving times of adjacent two addresses of the n+1 addresses whose order has been adjusted.

Optionally, when the taxi server determines that the n+1 addresses consisting of the start address and the n destination addresses meet the second preset condition, step 504 is performed; when the taxi server determines that the n+1 addresses do not meet the second preset condition, step 505 is performed.

As for the start address A0 and two destination addresses A1 and A2, after an order of the destination addresses is adjusted, the user YH will go to the destination address A2 firstly and then go to the destination address A1. If a driving distance between A0 and A1 is represented as S(A0A1), a driving distance between A1 and A2 is represented as S(A1A2), a driving distance between A0 and A2 is represented as S(A0A2), a driving distance between A2 and A1 is represented as S(A2A1), a driving time between A0 and A1 is represented as T(A0A1), a driving time between A1 and A2 is represented as T(A1A2), a driving time between A0 and A2 is represented as T(A0A2), and a driving time between A2 and A1 is represented as T(A2A1), then S₁=S(A0A1)+S(A1A2), S₃=S(A0A2)+S(A2A1), T₁=T(A0A1)+T(A1A2) and T₃=T(A0A2)+T(A2A1). Thus, when S(A0A1)+S(A1A2)>S(A0A2)+S(A2A1), or T(A0A1)+T(A1A2)>T(A0A2)+T(A2A1), or S(A0A1)+S(A1A2)>S(A0A2)+S(A2A1) and T(A0A1)+T(A1A2)>T(A0A2)+T(A2A1), the taxi server may determine that A0, A1, and A2 meet the second preset condition.

In the embodiment, the driving time is

$$T = \frac{S}{v} * λ ,$$

where S is a driving distance, v is an average speed, λ is a road congestion rate used to indicate the current congestion degree of the road. For example, when the current congestion degree of the road is extremely high, λ may be equal to 1.5. When the current congestion degree of the road is relatively high, λ may be equal to 1.2. When the current road is not congested, λ may be equal to 1. A value of λ may be set according to actual applications, and the embodiment of the present disclosure is not limited thereto. As an example,

$$T ( A 1 A 2 ) = \frac{S ( A 1 A 2 )}{v} * λ .$$

It is to be noted that, when the ordering information includes the stay time of the user being in the first destination address, in order to improve the accuracy of the calculation result, the stay time should be taken into account when the driving time is calculated. For example, it is known that the stay time of the user YH being in the destination address A1 is T′(A1A2), then the driving time between A1 and A2 will be

$$T ( A 1 A 2 ) = \frac{S ( A 1 A 2 )}{v} * λ + {T}^{′} ( A 1 A 2 ) .$$

In step 504, when the n+1 addresses meet the second preset condition, the taxi server adjusts an order of the n serial destination addresses.

When the n+1 addresses consisting of the start address and the n destination addresses meet the second preset condition, the taxi server may adjust the order of the n serial destination addresses. In the case of the user YH, the order of the two destination addresses before adjustment is A1→A2, and the order of the two destination addresses after adjustment is A2→A1. After the order of the n serial destination addresses is adjusted, step 505 is performed.

The method may adjust the order of the plurality of serial destination addresses according to the second preset condition, thus reducing the cost of booking a vehicle.

In step 505, the taxi server judges whether the first destination address meets a first preset condition.

In the embodiment, the first preset condition is:

t₁>a*t₂;

wherein the t₁ is the stay time of the user being at the first destination address, the t₂ is a driving time from the first destination address to a second destination address, the second destination address being a next destination address adjacent to the first destination address, the a being greater than 0 and less than 1. For example, a may be equal to ⅓.

Take the user YH as an example, in the first case, assuming that the three addresses do not meet the second preset condition, the taxi server does not adjust the order of two destination addresses, i.e., the order of the two destination addresses is still A1→A2, then the taxi server may judge whether the destination address A1 meets the first preset condition. In the first preset condition, t₁=T′(A1A2), t₂=T(A1A2), the taxi server judges whether t₁>a*t₂ is met. If it is, step 506 is performed and it is determined that the first order request needs to be divided, otherwise, it is determined that the first order request does not need to be divided.

In the second case, assuming that the three addresses meet the second preset condition, the taxi server adjusts the order of the two destination addresses to be A2→A1, the taxi server may judge whether the destination address A2 meets the first preset condition. At this time, in the first preset condition, t₁=T′(A2A1), t₂=T(A2A1), the taxi server judges whether t₁>a*t₂ is met. If it is, step 506 is performed and it is determined that the first order request needs to be divided, otherwise, it is determined that the first order request does not need to be divided.

In step 506, when the first destination address meets the first preset condition, the taxi server determines that the first order request needs to be divided.

When the first destination address meets the first preset condition, the taxi server determines that the first order request needs to be divided. Then, step 507 is performed to divide the first order request.

In step 507, when the first order request needs to be divided, the taxi server divides the first order request into m sub-order requests according to the ordering information.

2≦m≦n and the m is an integer. The taxi server divides the first order request into m sub-order requests according to the ordering information, and then takes the m sub-order requests as the second order request.

Specifically, step 507 may include:

dividing the first order request into a first sub-order request and a second sub-order request with the first destination address as a demarcation point, an end point in the first sub-order request is the first destination address, and a start point of the second sub-order request is the first destination address.

Taking the first case in step 505 as an example, the taxi server divides the first order request into two sub-order requests with the destination address A1 as the demarcation point, wherein the start point in one sub-order request is A0, the destination point in the one sub-order request is A1, the start point in the other sub-order request is A1 and the end point in the other sub-order request is A2.

Taking the second case in step 505 as an example, the taxi server divides the first order request into two sub-order requests with the destination address A2 as the demarcation point, wherein the start point in one sub-order request is A0, the destination point in the one sub-order request is A2, the start point in the other sub-order request is A2 and the end point in the other sub-order request is A1.

In addition, each sub-order request may include the name of the user YH and the telephone number of the user YH, or the like.

In step 508, the taxi server sends a dividing request to the user terminal.

The dividing request includes m sub-order requests, m, or dividing prompt information. That is, the dividing request may include m divided sub-order requests, the number m of the sub-order requests, or dividing prompt information. The embodiment of the present disclosure does not limit the specific form of the dividing prompt information. The taxi server may send a dividing request to the user terminal after dividing the order request into m sub-order requests, such that the user may determine whether to adopt the current dividing scheme.

In step 509, the user terminal sends a response of confirming dividing to the taxi server.

If the user determines to adopt the current dividing scheme, the user terminal receives a determination instruction and sends a response of confirming dividing to the taxi server.

In step 510, the taxi server sends them sub-order requests to at least m different vehicle-mounted terminals respectively.

Specifically, as shown in FIG. 5-5, step 510 may include following steps.

In step 5101, the taxi server sends the first sub-order request to at least one first vehicle-mounted terminal.

In step 5102, after the user has reached the first destination address and a preset time period has elapsed, the taxi server sends the second sub-order request to at least one second vehicle-mounted terminal.

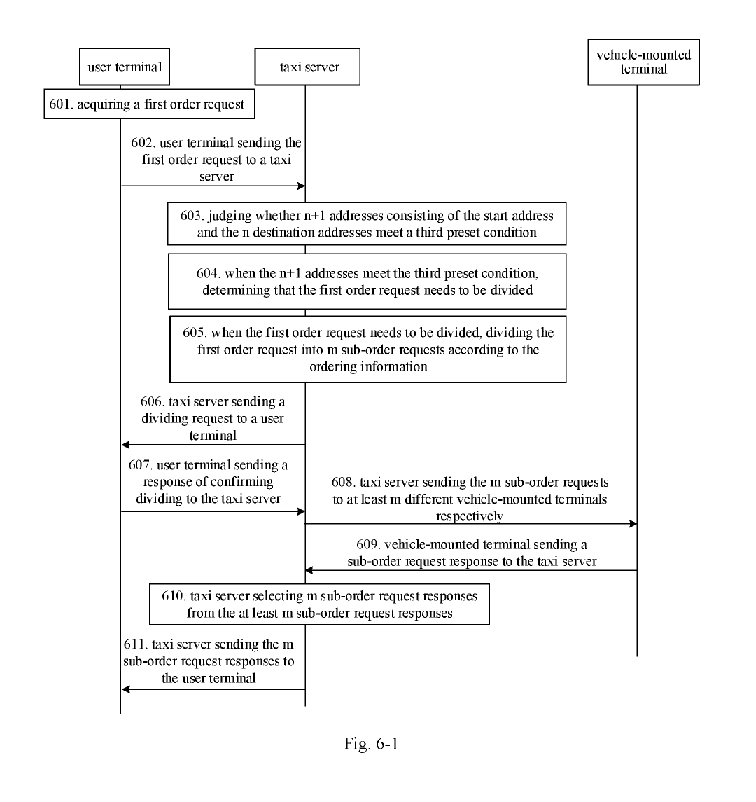

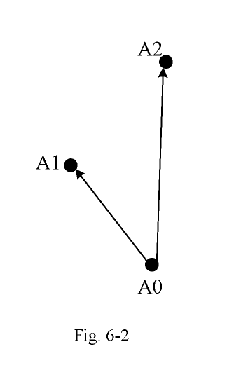

The preset time period is less than or equal to the t₁. Taking the first case in step 505 as an example, the taxi server firstly sends the sub-order request with the start point A0 obtained by the dividing to at least one vehicle-mounted terminal, and then sends the sub-order request with the start point A1 obtained by the dividing to at least one vehicle-mounted terminal. The specific process of how the taxi server determines two vehicle-mounted terminals to serve the user may refer to the prior art, which will not be repeated herein. If the taxi server directly sends a sub-order request with a start point A0 to the vehicle-mounted terminal Z1, after the user has reached the destination address A1 and a preset time period has elapsed, the taxi server directly sends a sub-order request with a start point A1 to the vehicle-mounted terminal Z2. The preset time period is less than or equal to the stay time T′(A1A2) of the user YH being in A1. FIG. 5-6 shows a schematic diagram of a taxi server interacting with vehicle-mounted terminals Z1 and Z2 respectively. It should be noted that, the steps prior to step 510 are not shown in FIG. 5-6, and the steps prior to step 510 may refer to steps 501 to 509 in FIG. 5-1.

In step 511, the vehicle-mounted terminal sends a sub-order request response to the taxi server.

Taking the first case in step 505 as an example, after the taxi server sends the sub-order request with the start point A0 to the vehicle-mounted terminal Z1, the vehicle-mounted terminal Z1 sends a sub-order request response to the taxi server. The sub-order request response includes vehicle information and driver information corresponding to the vehicle-mounted terminal Z1. In the embodiment, the vehicle information may include a vehicle color, a vehicle type, and a license plate number, and the driver information may include a name and a telephone number of a driver.

Similarly, after the taxi server sends the sub-order request with the start point A1 to the vehicle-mounted terminal Z2, the vehicle-mounted terminal Z2 sends a sub-order request response to the taxi server. The sub-order request response includes vehicle information and driver information corresponding to the vehicle-mounted terminal Z2.

In step 512, the taxi server selects m sub-order request responses from the at least m sub-order request responses.

Taking the first case in step 505 as an example, if the taxi server respectively sends the two sub-order requests to one vehicle-mounted terminal, the taxi server may directly send the sub-order request response sent by each vehicle-mounted terminal to the user terminal. If the taxi server sends the two sub-order requests to three vehicle-mounted terminals, each of the three vehicle-mounted terminals sends a sub-order request response to the taxi server, and the taxi server needs to select two sub-order request responses from the three sub-order request responses, and then sends the two sub-order request responses to the user terminal.

In step 513, the taxi server sends the m sub-order request responses to the user terminal.

Taking the first case in step 505 as an example, the taxi server sends the sub-order request response sent by the vehicle-mounted terminal Z1 to the user terminal. The sub-order request response includes the vehicle information and driver information corresponding to the vehicle-mounted terminal Z1. The taxi server sends the sub-order request response sent by the vehicle-mounted terminal Z2 to the user terminal. The sub-order request response includes the vehicle information and driver information corresponding to the vehicle-mounted terminal Z2. The taxi server sends the sub-order request response to the user terminal each time after receiving the sub-order request response sent from the vehicle-mounted terminal.

The order processing method provided by the embodiment of the present disclosure is applicable to the case where a single user goes to a plurality of serial destination addresses, and it is also applicable to the case where a plurality of users go to a plurality of serial destination addresses. The method may adjust the order of the destination addresses and divide the first order request to complete the vehicle booking process when the user inputs a plurality of serial destination addresses, which solves the problem that the user is required to temporarily direct a way for the driver or the driving route needs to be determined based on experience of the driver when the single user or the plurality of users go to a plurality of serial destination addresses in the prior art, which reduces the cost of booking a vehicle, improves reliability of booking a vehicle, and improves the user experience of hailing a taxi.

In an order processing method provided by the embodiment of the present disclosure, the taxi server may judge whether a first order request needs to be divided based on the ordering information in the first order request sent by the user terminal, the ordering information including a plurality of destination addresses. When it is confirmed that the first order request needs to be divided, the first order request will be divided into a plurality of sub-order requests based on the ordering information and the plurality of sub-order requests will be sent to a plurality of vehicle-mounted terminals. Compared with the comparison embodiment, when the user wants to go to a plurality of destination addresses, the method may divide the first order request into a plurality of sub-order requests when it is confirmed that the first order request needs to be divided. In this way, there is no necessity for the user to temporarily direct a way for the driver for each destination address or to determine the driving route based on experience of the driver, which improves reliability of booking a vehicle, and improves the user experience of hailing a taxi.

In view of above, in the order processing method provided by the embodiment of the present disclosure, a taxi server may receive a first order request sent by a user terminal and process the first order request to obtain a second order request, and then send the second order request to at least one vehicle-mounted terminal, wherein the first order request includes ordering information including a plurality of destination addresses. Compared with the comparison embodiment, the method is adapted to case where the ordering information includes a plurality of destination addresses. Through the method, the user may still successfully book a vehicle even when inputting a plurality of destination addresses, which improves reliability of booking a vehicle, improves the user experience of hailing a taxi, and reduces the cost of booking a vehicle.

FIG. 6-1 is a flow chart of an order processing method according to an exemplary embodiment. In the embodiment, for example, the order processing method is applied to the implementation environment as shown in FIG. 1. The order processing method may include following steps.

In step 601, a user terminal acquires a first order request.

The first order request includes ordering information, the ordering information at least including n destination addresses, n≧2 and the n being an integer.

Specifically, the user terminal receives the input information of the user, and the user terminal generates a first order request based on the input information. The input information includes n destination addresses. Assuming that the user YH and the user HX are currently in the address A0 (i.e., a start address), the user YH wants to go to the destination address A1, the user HX wants to go to the destination address A2, and the user YH is the person who places an order. The user YH may input the two destination addresses A1 and A2 through the ordering page as shown in FIG. 5-3, and then select the “parallel” option. Alternatively, the user YH inputs two destination addresses A1 and A2 in Table 2. Alternatively, the user YH draws a route map on the ordering page. As shown in FIG. 6-2, the user terminal may determine that the two destination addresses A1 and A2 are two parallel destination addresses that the user expects to reach, according to endpoint names, the number of endpoints and indicating arrows on the lines in the route map. The ordering information may include a start address and an address type identification, the address type identification is used to indicate that the n destination addresses are n parallel destination addresses that a user expects to reach. In addition, the ordering information further includes user information, which may include a telecommunication number of the user and an identification of the user.

In step 602, the user terminal sends the first order request to a taxi server.

After the taxi server receives the first order request sent from the user terminal, since the ordering information includes the address type identification being used to indicate that the n destination addresses are n parallel destination addresses that a user expects to reach, the taxi server may determine the n destination addresses are n parallel destination addresses based on the address type identification.

Taking the user YH and the user HX as an example, the ordering information of the first order request sent by the user terminal to the taxi server may include: the start address A0, two destination addresses A1 and A2, the name of the user YH, the telephone number of the user YH.

In step 603, the taxi server judges whether n+1 addresses consisting of the start address and the n destination addresses meet a third preset condition.

The third preset condition is:

S₁>S₂;

or, T₁>T₂;

or, S₁>S₂ and T₁>T₂;

wherein the S₁ is a sum of driving distances of adjacent two addresses of the n+1 addresses, the S₂ is a sum of driving distances from the start address to each of the n destination addresses, the T₁ is a sum of driving times of adjacent two addresses of the n+1 addresses, and the T₂ is a sum of driving times from the start address to each of the n destination addresses.

Optionally, when the taxi server determines that n+1 addresses consisting of the start address and the n destination addresses meet the third preset condition, step 604 is performed and it is determined that the first order request needs to be divided; when the taxi server determines that n+1 addresses consisting of the start address and the n destination addresses do not meet the third preset condition, it is determined not to divide the first order request.

Taking the user YH and the user HX as an example, as for the start address A0 and two destination addresses A1 and A2, if a driving distance between A0 and A1 is represented as S(A0A1), a driving distance between A1 and A2 is represented as S(A1A2), a driving distance between A0 and A2 is represented as S(A0A2), a driving time between A0 and A1 is represented as T(A0A1), a driving time between A1 and A2 is represented as T(A1A2), and a driving time between A0 and A2 is represented as T(A0A2), then S₁=S(A0A1)+S(A1A2), S₂=S(A0A1)+S(A0A2), T₁=T(A0A1)+T(A1A2) and T₂=T(A0A1)+T(A0A2). Thus, when S(A0A1)+S(A1A2)>S(A0A1)+S(A0A2), or T(A0A1)+T(A1A2)>T(A0A1)+T(A0A2), or S(A0A1)+S(A1A2)>S(A0A1)+S(A0A2) and T(A0A1)+T(A1A2)>T(A0A1)+T(A0A2), the taxi server may determine that A0, A1, and A2 meet the third preset condition.

In the embodiment, the calculation formula of the driving time may refer to T=S/v*λ in step 503, which will not be repeated herein.

In step 604, when the n+1 addresses meet the third preset condition, the taxi server determines that the first order request needs to be divided.

When the n+1 addresses meet the third preset condition, the taxi server determines that the first order request needs to be divided, and then the step 605 is performed to divide the first order request.

In step 605, when the first order request needs to be divided, the taxi server divides the first order request into m sub-order requests according to the ordering information.

The taxi server divides the first order request into m sub-order requests according to the ordering information, and then takes the m sub-order requests as the second order request.

In particular, step 605 may include:

dividing the first order request into m sub-order requests according to the ordering information, the m being equal to the n, a start point in each of the sub-order requests being the start address, and an end point in each of the sub-order requests being one of the n destination addresses.

Further, on one hand, the ordering information further includes user information including a telecommunication number of the target user. Each sub-order request includes a start address, n destination addresses, and the telecommunication number of the target user. Optionally, the user information further includes an identification of the target user, and each sub-order request further includes the identification of the target user.

On the other hand, the ordering information further includes user information including telecommunication numbers of n users and an address number correspondence relationship, the address number correspondence relationship being used to record a correspondence relationship between a destination address and a telecommunication number of a user, the n users including target users, each of the sub-order requests includes the start address, one of the n destination addresses, and a telecommunication number of a user corresponding to one of the n destination addresses. Optionally, the user information further includes an identification of the target user, and each sub-order request further includes the identification of the target user.

It is to be noted that each sub-order request may include a destination address or may not include a destination address. When the destination address is not included, the user may tell the driver where he/she wants to go, and the embodiment of the present disclosure is not limited thereto.

Taking the user YH and user HX as an example, after determining that the first order request needs to be divided, the taxi server divides the first order request into two sub-order requests according to the ordering information. In one sub-order request, the start point is A0, and the end point is A1, and the sub-order request is used to serve the user YH. In the other sub-order request, the start point is A0, and the end point is A2, and the other sub-order request is used to serve the user HX. In addition, each sub-order request further includes the name of the user YH and the telephone number of the user YH.

In the above process, since each sub-order request includes the telephone number of the user YH, if the vehicle serving the user YH arrives at A0 firstly and the vehicle serving the user HX arrives at the A0 later, the user YH will leave A0 firstly and the user HX will leave A0 later, which will bring inconvenience for the user HX to hail a taxi. In order to avoid this case, on one hand, the ordering information further includes user information including the name of the user YH and the telephone number of the user YH. One sub-order request may include the start address A0, the two destination addresses A1 and A2, the name of the user YH and the telephone number of the user YH, and the other sub-order request may include the start address A0, the two destination addresses A1 and A2, the name of the user YH and the telephone number of the user YH. Since each sub-order request includes A1 and A2, the user HX may be served by either one of the vehicles. In this way, if the two vehicles do not reach A0 at the same time, the user YH may leave A0 after the user HX leaves A0.

On the other hand, the ordering information further includes user information, including the name of the user YH, the telephone number of the user YH, the telephone number of the user HX, and the address number correspondence relationship. The address number correspondence relationship may be shown in Table 3, in which 150xxxxxxxx is the telephone number of the user YH, 138yyyyyyyy is the telephone number of the user HX. One sub-order request divided by the taxi server according to the ordering information may include the start address A0, the destination address A1, the name of the user YH, and the telephone number of the user YH, and the other sub-order request may include the start address A0, the destination address A2, the name of the user YH and the telephone number of the user HX. In this way, the vehicle-mounted terminal serving the user YH may acquire the telephone number of the user YH, and the vehicle-mounted terminal serving the user HX may acquire the telephone number of the user HX. Therefore, the user YH may leave A0 without waiting for the user HX to leave A0, which improves the user experience of hailing a taxi.

TABLE 3

| | Telecommunication number of |
|---|---|
| Destination address | the user |
| A1 | 150xxxxxxxx |
| A2 | 138yyyyyyyy |

In step 606, the taxi server sends a dividing request to a user terminal.

The dividing request includes m sub-order requests, m, or dividing prompt information. The taxi server may send a dividing request to the user terminal after dividing the order request into m sub-order requests, such that the user may determine whether to adopt the current dividing scheme.

In step 607, the user terminal sends a response of confirming dividing to the taxi server.

If the user determines to adopt the current dividing scheme, the user terminal receives a determination instruction and sends a response of confirming dividing to the taxi server.

In step 608, the taxi server sends the m sub-order requests to at least m different vehicle-mounted terminals respectively.

Taking the user YH and the user HX as an example, the taxi server may send a sub-order request to at least one vehicle-mounted terminal and send the other sub-order request to at least one vehicle-mounted terminal. The specific process of how the taxi server determines two vehicle-mounted terminals to serve the users may refer to the prior art.

In step 609, the vehicle-mounted terminal sends a sub-order request response to the taxi server.

The sub-order request response includes vehicle information and driver information corresponding to the vehicle-mounted terminal. Taking the user YH and the user HX as an example, if the taxi server sends a sub-order request to the vehicle-mounted terminal Z1 and the other sub-order request to the vehicle-mounted terminal Z2 directly, the vehicle-mounted terminal Z1 will send a sub-order request response to the taxi server after the taxi server sends to the vehicle-mounted terminal Z1 the sub-order request, the sub-order request response including vehicle information and driver information corresponding to the vehicle-mounted terminal Z1. After the taxi server sends the sub-order request to the vehicle-mounted terminal Z2, the vehicle-mounted terminal Z2 will send to the taxi server a sub-order request response including vehicle information and driver information corresponding to the vehicle-mounted terminal Z2. The interacting process between the taxi server and the vehicle-mounted terminals Z1 and Z2 respectively may refer to FIG. 5-6.

It is to be noted that when each sub-order request divided by the taxi server includes the start address, the n destination address, and the telecommunication number of the target user, the vehicle-mounted terminal needs to select one from the n destination addresses to serve as the end point of the sub-order request. Correspondingly, after the vehicle-mounted terminal sends a sub-order request response to the taxi server, the method further includes: the vehicle-mounted terminal displaying the n destination addresses; the vehicle-mounted terminal receiving a selection instruction for instructing to select one from the n destination addresses to serve as an end point; and the vehicle-mounted terminal selecting one from the n destination addresses as an end point according to the selection instruction. For example, taking the user YH and the user HX as an example, assuming that one sub-order request divided by the taxi server may include the start address A0, the two destination addresses A1 and A2, the name of the user YH and the telephone number of the user YH, and the other sub-order request may include the start address A0, the two destination addresses A1 and A2, the name of the user HX and the telephone number of the user HX, the vehicle-mounted terminal needs to select one from the two destination addresses A1 and A2 to serve as the end point according to the user's instruction, in order to facilitate serving the user YH or user HX.

In step 610, the taxi server selects m sub-order request responses from the at least m sub-order request responses.

Taking the vehicle-mounted terminal Z1 and the vehicle-mounted terminal Z2 in step 609 as an example, the taxi server will send two sub-order request responses directly to the user terminal after receiving sub-order request responses sent by the two vehicle-mounted terminals respectively. If the taxi server receives more than three sub-order request responses, two sub-order request responses need to be selected from the three sub-order request responses, and then the taxi server sends the two sub-order request responses to the user terminal.

In step 611, the taxi server sends the m sub-order request responses to the user terminal.

Taking the vehicle-mounted terminal Z1 and the vehicle-mounted terminal Z2 in step 609 as an example, the taxi server sends the sub-order request response sent by the vehicle-mounted terminal Z1 to the user terminal. The sub-order request response includes the vehicle information and driver information corresponding to the vehicle-mounted terminal Z1. The taxi server sends the sub-order request response sent by the vehicle-mounted terminal Z2 to the user terminal. The sub-order request response includes the vehicle information and driver information corresponding to the vehicle-mounted terminal Z2. The taxi server sends the sub-order request response to the user terminal each time after receiving the sub-order request response sent from the vehicle-mounted terminal.

The order processing method provided by the embodiment of the present disclosure is applicable to the case where a plurality of users go to a plurality of parallel destination addresses. The method may divide the first order request to complete the vehicle booking process when the user inputs a plurality of parallel destination addresses, which solves the problem that the demand of a plurality of users to hail a taxi at the same time cannot be met. Through the method, there is no necessity for the user to temporarily direct a way for the driver or to determine the driving route based on experience of the driver, which improves reliability of booking a vehicle, and improves the user experience of hailing a taxi.

In an order processing method provided by the embodiment of the present disclosure, the taxi server may judge whether a first order request needs to be divided based on the ordering information in the first order request sent by the user terminal, the ordering information including a plurality of destination addresses. When it is confirmed that the first order request needs to be divided, the first order request will be divided into a plurality of sub-order requests based on the ordering information and the plurality of sub-order requests will be sent to a plurality of vehicle-mounted terminals. Compared with the comparison embodiment, when a plurality of users want to go to a plurality of parallel destination addresses, the method may divide the first order request into a plurality of sub-order requests when it is confirmed that the first order request needs to be divided. In this way, there is no necessity for the user to temporarily direct a way for the driver for each destination address or to determine the driving route based on experience of the driver, which improves reliability of booking a vehicle, and improves the user experience of hailing a taxi.

In view of above, in the order processing method provided by the embodiment of the present disclosure, a taxi server may receive a first order request sent by a user terminal and process the first order request to obtain a second order request, and then send the second order request to at least one vehicle-mounted terminal, wherein the first order request includes ordering information including a plurality of destination addresses. Compared with the comparison embodiment, the method is adapted to case where the ordering information includes a plurality of destination addresses. Through the method, the user may still successfully book a vehicle even when inputting a plurality of destination addresses, which improves reliability of booking a vehicle and improves the user experience of hailing a taxi.

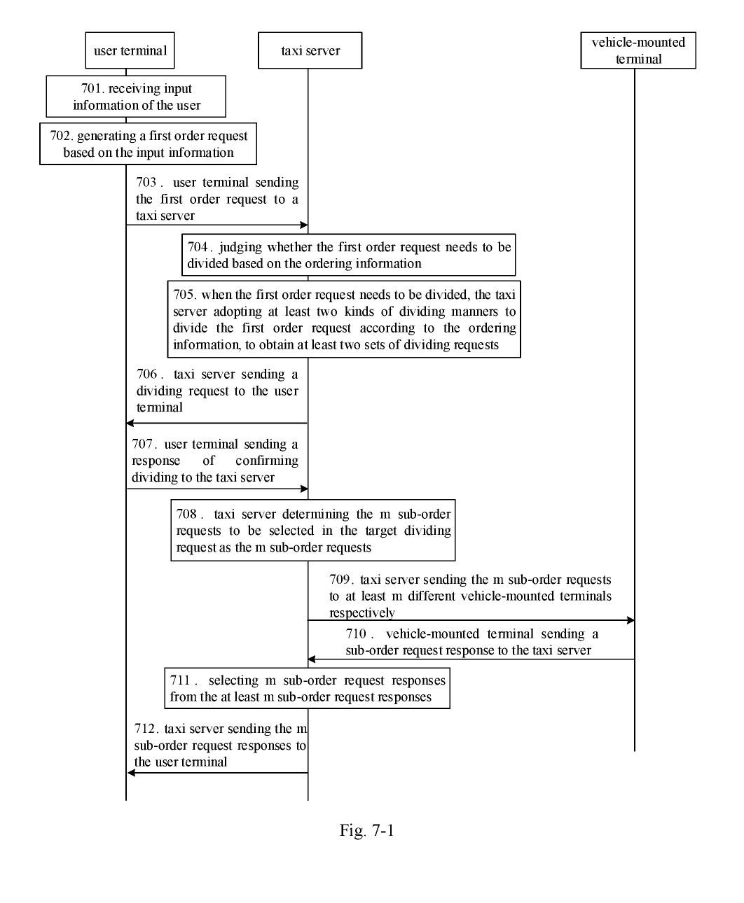

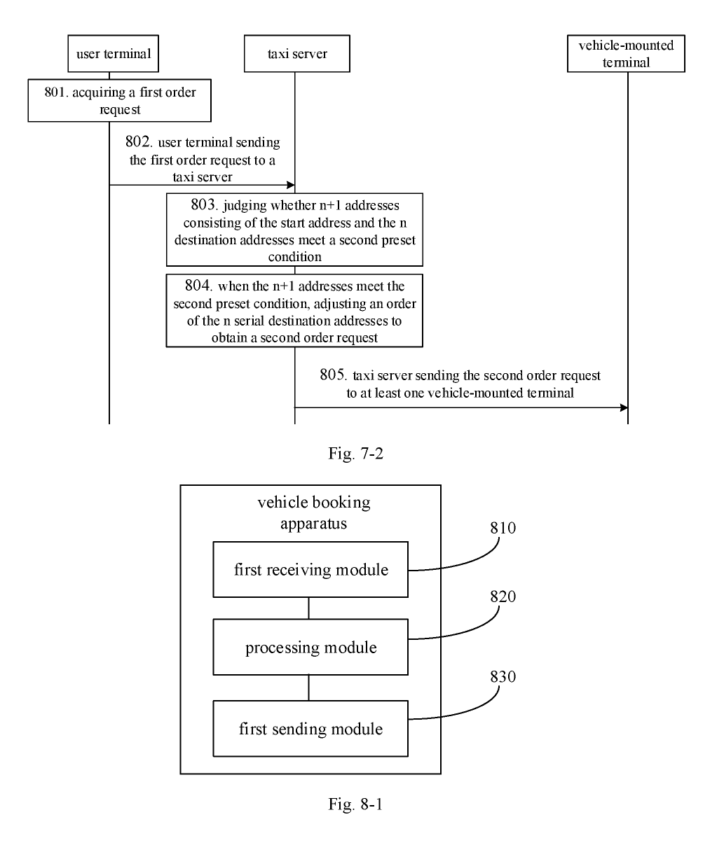

FIG. 7-1 is a flow chart of an order processing method according to an exemplary embodiment. In the embodiment, for example, the order processing method is applied to the implementation environment as shown in FIG. 1. The order processing method may include following steps.

In step 701, a user terminal receives input information of the user.

The input information includes n destination addresses, n≧2 and the n is an integer.

The user terminal may send the first order request including the n destination addresses to the taxi server, and the taxi server divides the first service request through a plurality of dividing manners to obtain a plurality of dividing schemes, and then the user selects one dividing scheme which may meet requirement of the user.

Assuming that the user YH is currently in an address A0 (i.e., the start address), if the user YH wants to go to a destination address A1 firstly and then go to a destination address A2, as shown in FIG. 5-3. The user YH inputs two destination addresses A1 and A2 via the ordering page of the user terminal but the user does not select the “serial” option. Alternatively, neither two options “serial” and “parallel” nor the tables shown in Table 1 and Table 2 are displayed in the ordering page of the user terminal. In this case, the user terminal may send the two destination addresses to the taxi server, and the taxi server will recommend a plurality of dividing schemes to the user for the user YH to select.

In step 702, the user terminal generates a first order request based on the input information.

The first order request includes ordering information, the ordering information at least including n destination addresses.

For example, when the user YH inputs two destination addresses A1 and A2, the ordering information may include: the start address A0, two destination addresses A1 and A2, the name of the user YH, the telephone number of the user YH.

In step 703, the user terminal sends the first order request to a taxi server.

The user terminal sends the generated first order request to the taxi server, such that the taxi server judges whether the first order request needs to be divided.

In step 704, the taxi server judges whether the first order request needs to be divided based on the ordering information.

On one hand, the taxi server may take the n destination addresses included in the ordering information as n serial destination addresses, and the process of the taxi server judging whether the first order request needs to be divided based on the ordering information may refer to step 505 and step 506. In addition, the taxi server may also judge whether the order of the n serial destination addresses needs to be adjusted, referring to step 503 and step 504 for details.

On the other hand, the taxi server may take the n destination addresses included in the ordering information as n parallel destination addresses, and the process of the taxi server judging whether the first order request needs to be divided based on the ordering information may refer to step 603 and step 604, which will not be repeated herein.

In step 705, when the first order request needs to be divided, the taxi server adopts at least two kinds of dividing manners to divide the first order request according to the ordering information, to obtain at least two sets of dividing requests.

Each set of the dividing requests includes: m sub-order requests to be selected, 2≦m≦n and the m being an integer. For example, when the user YH inputs two destination addresses A1 and A2, the taxi server divides the first order request according to the ordering information by two kinds of dividing manners.

When the taxi server takes the n destination addresses as n serial destination addresses, the taxi server may divide the first order request with the dividing manner described in step 506 to obtain a set of dividing requests. The set of dividing requests includes two sub-order requests to be selected, one of which may include: the start address A0, the destination address A1, the name of the user YH, and the telephone number of the user YH, and the other of which may include: the destination address A1 (i.e., the start point of the sub-order request to be selected), the destination address A2, the name of the user YH, and the telephone number of the user YH.

When the taxi server takes the n destination addresses as n parallel destination addresses, the taxi server may divide the first order request with the dividing manner described in step 605 to obtain a set of dividing requests. The set of dividing requests includes two sub-order requests to be selected, one of which may include: the start address A0, the two destination addresses A1 and A2, the name of the user YH, and the telephone number of the user YH, and the other of which may include: the start address A0, the two destination addresses A1 and A2, the name of the user YH, and the telephone number of the user YH.

In step 706, the taxi server sends a dividing request to the user terminal.

The dividing request includes at least two sets of dividing requests. After receiving the at least two sets of dividing requests, the taxi server sends the at least two sets of dividing requests to the user terminal, such that the user terminal confirms one set of dividing requests from the at least two sets of dividing requests.

In step 707, the user terminal sends a response of confirming dividing to the taxi server.

The response includes a set of target dividing requests confirmed by the user terminal in the at least two sets of dividing requests.

Taking the two sets of dividing requests in step 705 as an example, assuming that a set of target dividing requests confirmed by the user terminal in the two sets of dividing requests is one set of dividing requests obtained by the taxi server dividing the first order request by taking the n destination addresses as n serial destination addresses. The user terminal sends a response of confirming dividing to the taxi server. The response includes a set of target dividing requests confirmed by the user terminal in the two sets of dividing requests.

In step 708, the taxi server determines the m sub-order requests to be selected in the target dividing request as the m sub-order requests.

After receiving the response of confirming dividing sent by the user terminal, the taxi server determines the m sub-order requests to be selected of the target dividing request included in the response as m sub-order requests and takes the m sub-order requests as the second order request.

In step 709, the taxi server sends the m sub-order requests to at least m different vehicle-mounted terminals respectively.

This step may refer to step 510 or step 608, which will not be repeated herein.

In step 710, the vehicle-mounted terminal sends a sub-order request response to the taxi server.

The sub-order request response includes vehicle information and driver information corresponding to the vehicle-mounted terminal. This step may refer to step 511 or step 609, which will not be repeated herein.

In step 711, the taxi server selects m sub-order request responses from the at least m sub-order request responses.

This step may refer to step 512 or step 610, which will not be repeated herein.

In step 712, the taxi server sends the m sub-order request responses to the user terminal.

This step may refer to step 513 or step 611, which will not be repeated herein.

The order processing method provided by the embodiment of the present disclosure is applicable to the case where a plurality of users go to a plurality of destination addresses. The method will recommend a plurality of dividing schemes to the user based on the plurality of destination addresses input by the user, such that the user may select one from the plurality of dividing schemes to complete the vehicle booking process, which greatly meets the user's demand to hail a taxi and improves the user's experience of hailing a taxi. The method analyzes the plurality of destination addresses input by the user, and divides the first order request into a plurality of sub-order requests when the plurality of destination addresses meet the preset condition, which reduces the cost of booking a vehicle, improves the travel efficiency of the user, and optimizes path planning.

In an order processing method provided by the embodiment of the present disclosure, the taxi server may judge whether a first order request needs to be divided based on the ordering information in the first order request sent by the user terminal, the ordering information including a plurality of destination addresses. When it is confirmed that the first order request needs to be divided, the first order request will be divided into a plurality of sub-order requests based on the ordering information and the plurality of sub-order requests will be sent to a plurality of vehicle-mounted terminals. Compared with the comparison embodiment, when the user wants to go to a plurality of destination addresses, the method may divide the first order request into a plurality of sub-order requests when it is confirmed that the first order request needs to be divided, and recommend a variety of dividing schemes to the user for the user to select. In this way, there is no necessity for the user to temporarily direct a way for the driver for each destination address or to determine the driving route based on experience of the driver, which improves reliability of booking a vehicle, and improves the user experience of hailing a taxi.

In view of above, in the order processing method provided by the embodiment of the present disclosure, a taxi server may receive a first order request sent by a user terminal and process the first order request to obtain a second order request, and then send the second order request to at least one vehicle-mounted terminal, wherein the first order request includes ordering information including a plurality of destination addresses. Compared with the comparison embodiment, the method is adapted to case where the ordering information includes a plurality of destination addresses. Through the method, the user may still successfully book a vehicle even when inputting a plurality of destination addresses, which improves reliability of booking a vehicle, improves the user experience of hailing a taxi, and reduces the cost of booking a vehicle.

FIG. 7-2 is a flow chart of an order processing method according to an exemplary embodiment. In the embodiment, for example, the order processing method is applied to the implementation environment as shown in FIG. 1. The order processing method may include following steps.

In step 801, a user terminal acquires a first order request.

The first order request includes ordering information, the ordering information at least including n destination addresses, n≧2 and the n being an integer. The ordering information further includes an address type identification and a start address. The address type identification is used to indicate that the n destination addresses are n serial destination addresses that a user expects to reach successively.

The specific process of step 801 may refer to step 501.

In step 802, the user terminal sends the first order request to a taxi server.

After the taxi server receives the first order request sent from the user terminal, since the ordering information includes the address type identification being used to indicate that the n destination addresses are n serial destination addresses that the user expects to reach successively, the taxi server may determine that the n destination addresses are n serial destination addresses based on the address type identification.

In step 803, the taxi server judges whether n+1 addresses consisting of the start address and the n destination addresses meet a second preset condition.

The second preset condition is:

S₁>S₃;

or, T₁>T₃;

or, S₁>S₃ and T₁>T₃;

wherein the S₁ is a sum of driving distances of adjacent two addresses of the n+1 addresses, the S₃ is a sum of driving distances of adjacent two addresses of the n+1 addresses whose order has been adjusted, the T₁ is a sum of driving times of adjacent two addresses of the n+1 addresses, and the T₃ is a sum of driving times of adjacent two addresses of the n+1 addresses whose order has been adjusted.

The specific process of step 803 may refer to step 503.

In step 804, when the n+1 addresses meet the second preset condition, the taxi server adjusts an order of the n serial destination addresses to obtain a second order request.

Step 804 may refer to step 504. The order of the plurality of destination addresses in the second order request is different from the order of the plurality of destination addresses in the ordering information included in the first order request. The method may adjust the order of the plurality of serial destination addresses by the second preset condition, and the cost of booking a vehicle may be reduced.

In step 805, the taxi server sends the second order request to at least one vehicle-mounted terminal.

The taxi server may send an adjustment request to the user terminal before sending the second order request to at least one vehicle-mounted terminal, such that the user may determine whether to adopt the current adjustment scheme. If the user determines to adapt the current adjustment scheme, the user terminal receives a determination instruction and sends a response of confirming adjusting to the taxi server.

After the taxi server sends the second order request to the at least vehicle-mounted terminal, the vehicle-mounted terminal will send the vehicle information and driver information corresponding to the vehicle-mounted terminal to the taxi server, such that the taxi server sends the corresponding vehicle information and driver information to the user terminal, to complete the entire vehicle booking process. The taxi server may send the second order request to one vehicle-mounted terminal, or to a plurality of vehicle-mounted terminals. When the taxi server sends the second order request to the plurality of vehicle-mounted terminals, the taxi server is required to select one from the plurality of vehicle-mounted terminals to serve the user. The selection process may refer to the prior art.

The order processing method provided by the embodiment of the present disclosure is applicable to the case where a single user or a plurality of users goes to a plurality of serial destination addresses. The method may adjust the order of the plurality of destination addresses to complete the vehicle booking process when the user inputs a plurality of serial destination addresses, which reduces the cost of booking a vehicle, improves the travel efficiency of the user, and optimizes path planning.

In view of above, in the order processing method provided by the embodiment of the present disclosure, a taxi server may receive a first order request sent by a user terminal and process the first order request to obtain a second order request, and then send the second order request to at least one vehicle-mounted terminal, wherein the first order request includes ordering information including a plurality of destination addresses. Compared with the comparison embodiment, the method is adapted to case where the ordering information includes a plurality of destination addresses. Through the method, the user may still successfully book a vehicle even when inputting a plurality of destination addresses, which improves reliability of booking a vehicle, improves the user experience of hailing a taxi, and reduces the cost of booking a vehicle.

It is to be noted that the order of steps of the order processing method provided by the embodiment of the present disclosure may be appropriately adjusted and the steps may also be added or reduced accordingly depending on circumstances. Variations of the method that may be easily conceived by those skilled in the art within the technical scope disclosed in the present disclosure should be covered by the protection scope of the present disclosure, which will not be repeated herein.

The following is apparatus embodiments of the present disclosure, which may be used to carry out the method embodiments of the present disclosure. Details that are not disclosed in the apparatus embodiments of the present disclosure may refer to the method embodiments of the present disclosure.

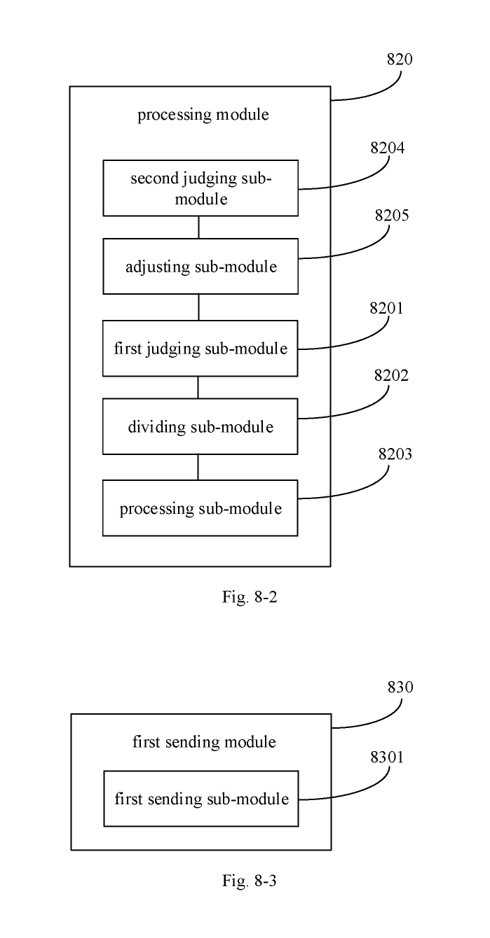

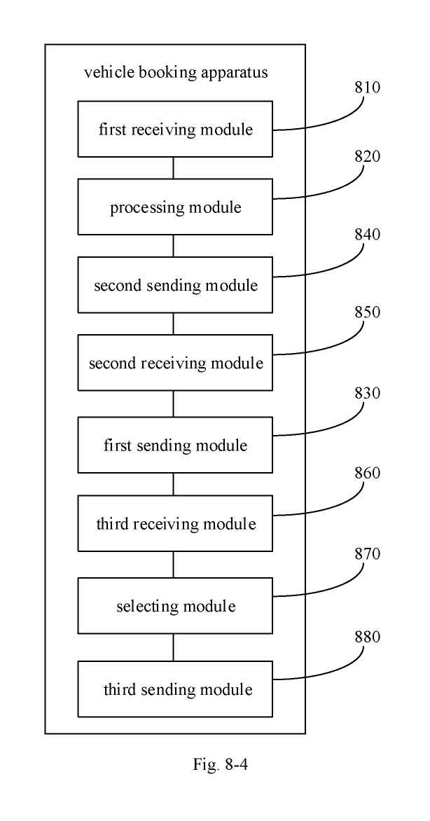

FIG. 8-1 is a block diagram of a vehicle booking apparatus according to an exemplary embodiment. The vehicle booking apparatus may be implemented as part or all of a taxi server by software, hardware, or a combination thereof. The vehicle booking apparatus may include:

a first receiving module 810, configured to receive a first order request from a user terminal, the first order request including ordering information, the ordering information at least including n destination addresses, n≧2 and the n being an integer;

a processing module 820, configured to process the first order request according to the n destination addresses, to obtain a second order request; and

a first sending module 830, configured to send the second order request to at least one vehicle-mounted terminal.

In an embodiment, the vehicle booking apparatus may include a processor; and a memory, for storing instructions executable by the processor, wherein the processor is configured to: receive a first order request sent from a user terminal, the first order request including ordering information, the ordering information at least including n destination addresses, n≧2 and the n being an integer; process the first order request according to the n destination addresses, to obtain a second order request; and send the second order request to at least one vehicle-mounted terminal.

In view of above, in the order processing apparatus provided by the embodiment of the present disclosure, the apparatus may receive a first order request sent from a user terminal, and process the first order request to obtain a second order request, and then send the second order request to at least one vehicle-mounted terminal. In the embodiment, the first order request includes ordering information, and the ordering information includes a plurality of destination addresses. Compared with the comparison embodiment, the apparatus is applicable to the case where the ordering information includes a plurality of destination addresses. Through the apparatus, the user may still book a vehicle successfully even when inputting a plurality of destination addresses, thus improving the reliability of booking a vehicle.

Specifically, as shown in FIG. 8-2, the processing module 820 includes:

a first judging sub-module 8201, configured to judge whether the first order request needs to be divided according to the ordering information;

a dividing sub-module 8202, configured to when the first order request needs to be divided, divide the first order request into m sub-order requests according to the ordering information, 2≦m≦n and the m being an integer; and

a processing sub-module 8023, configured to take the m sub-order requests as the second order request.

Correspondingly, as shown in FIG. 8-3, the first sending module 830 includes:

a first sending sub-module 8301, configured to send the m sub-order requests to at least m different vehicle-mounted terminals respectively.

Further, as shown in FIG. 8-4, the apparatus further includes:

a second sending module 840, configured to send a dividing request to a user terminal, the dividing request including m sub-order requests, m, or dividing prompt information; and

a second receiving module 850, configured to receive a response of confirming dividing sent by the user terminal.

Optionally, the ordering information further includes an address type identification for indicating that the n destination addresses are n serial destination addresses that a user expects to reach successively, and the ordering information further includes a stay time of the user being at a first destination address, the first destination address being any one of the n destination addresses except for a last destination address.

The first judging sub-module 8201 is configured to:

judge whether the first destination address meets a first preset condition; and

when the first destination address meets the first preset condition, determine that the first order request needs to be divided.

The dividing sub-module 8202 is configured to:

divide the first order request into a first sub-order request and a second sub-order request with the first destination address as a demarcation point, an end point in the first sub-order request being the first destination address, and a start point of the second sub-order request being the first destination address,

wherein the first preset condition is:

t₁>a*t₂;

wherein the t₁ is the stay time of the user being at the first destination address, the t₂ is a driving time from the first destination address to a second destination address, the second destination address being a next destination address adjacent to the first destination address, the a being greater than 0 and less than 1.

Specifically, the first sending sub-module 8301 is configured to:

send the first sub-order request to at least one first vehicle-mounted terminal; and

after the user has reached the first destination address and a preset time period has elapsed, send the second sub-order request to at least one second vehicle-mounted terminal, the preset time period being less than or equal to the t₁.

Further, as shown in FIG. 8-2, the ordering information further includes a start address, and the processing module 820 further includes:

a second judging sub-module 8204, configured to judge whether n+1 addresses consisting of the start address and the n destination addresses meet a second preset condition; and

an adjusting sub-module 8205, configured to when the n+1 addresses meet the second preset condition, adjust an order of the n serial destination addresses,

wherein the second preset condition is:

S₁>S₃;

or, T₁>T₃;

or, S₁>S₃ and T₁>T₃;

wherein the S₁ is a sum of driving distances of adjacent two addresses of the n+1 addresses, the S₃ is a sum of driving distances of adjacent two addresses of the n+1 addresses whose order has been adjusted, the T₁ is a sum of driving times of adjacent two addresses of the n+1 addresses, and the T₃ is a sum of driving times of adjacent two addresses of the n+1 addresses whose order has been adjusted.

Optionally, the ordering information further includes a start address and an address type identification, the address type identification being used to indicate that the n destination addresses are n parallel destination addresses that a user expects to reach.

The first judging sub-module 8201 is configured to:

judge whether n+1 addresses consisting of the start address and the n destination addresses meet a third preset condition; and

when the n+1 addresses meet the third preset condition, determine that the first order request needs to be divided.

The dividing sub-module 8202 is configured to:

divide the first order request into m sub-order requests according to the ordering information, the m being equal to the n, a start point in each of the sub-order requests being the start address, and an end point in each of the sub-order requests being one of the n destination addresses,

wherein the third preset condition is:

S₁>S₂;

or, T₁>T₂;

or, S₁>S₂ and T₁>T₂;

wherein the S₁ is a sum of driving distances of adjacent two addresses of the n+1 addresses, the S₂ is a sum of driving distances from the start address to each of the n destination addresses, the T₁ is a sum of driving times of adjacent two addresses of the n+1 addresses, and the T₂ is a sum of driving times from the start address to each of the n destination addresses.

On one hand, the ordering information further includes user information including a telecommunication number of a target user, each of the sub-order request includes the start address, the n destination addresses and the telecommunication number of the target user. Optionally, the user information further includes the identification of the target user, and each of the sub-order request further includes the identification of the target user.

The telecommunication number of the target user may be represented directly by the telephone number of the target user, or may be represented by a part of the telephone number, or may also be represented by any number identification which can uniquely indicate the telephone number. The disclosure is not limited thereto. For example, the identification of the target user is the name of the target user.

On the other hand, the ordering information further includes user information including telecommunication numbers of n users and an address number correspondence relationship, the address number correspondence relationship being used to record a correspondence relationship between a destination address and a telecommunication number of a user, the n users including a target user. Each of the sub-order requests includes the start address, one of the n destination addresses, and a telecommunication number of a user corresponding to one of the n destination addresses. Optionally, the user information further includes the identification of the target user, and each of the sub-order request further includes the identification of the target user.

Optionally, the dividing sub-module 8202 is configured to:

divide the first order request according to the ordering information to obtain at least two sets of dividing requests through at least two dividing manners, each set of the dividing requests including: m sub-order requests to be selected;

send a dividing request to the user terminal, the dividing request including the at least two sets of dividing requests;

receive a response of confirming dividing sent from the user terminal, the response including a set of target dividing requests confirmed by the user terminal in the at least two sets of dividing requests; and

determine the m sub-order requests to be selected in the target dividing request as the m sub-order requests.

Further, as shown in FIG. 8-4, the apparatus further includes:

a third receiving module 860, configured to receive a sub-order request response sent by the at least m different vehicle-mounted terminals respectively, the sub-order request response including vehicle information and driver information corresponding to a vehicle-mounted terminal;

a selecting module 870, configured to select m sub-order request responses from the at least m sub-order request responses; and

a third sending module 880, configured to send the m sub-order request responses to the user terminal.

The meaning of other reference numerals in FIG. 8-4 may refer to FIG. 8-1.

Optionally, the ordering information further includes an address type identification and a start address. The address type identification is used to indicate that the n destination addresses are n serial destination addresses that a user expects to reach successively.

The processor module 820 is configured to:

judge whether n+1 addresses consisting of the start address and the n destination addresses meet a second preset condition;

when the n+1 addresses meet the second preset condition, adjust an order of the n serial destination addresses and obtaining the second order request,

wherein the second preset condition is:

S₁>S₃;

or, T₁>T₃;

or, S₁>S₃ and T₁>T₃;

wherein the S₁ is a sum of driving distances of adjacent two addresses of the n+1 addresses, the S₃ is a sum of driving distances of adjacent two addresses of the n+1 addresses whose order has been adjusted, the T₁ is a sum of driving times of adjacent two addresses of the n+1 addresses, and the T₃ is a sum of driving times of adjacent two addresses of the n+1 addresses whose order has been adjusted.

In an order processing apparatus provided by the embodiment of the present disclosure, the apparatus may judge whether a first order request needs to be divided based on the ordering information in the first order request sent by the user terminal, the ordering information including a plurality of destination addresses. When it is confirmed that the first order request needs to be divided, the first order request will be divided into a plurality of sub-order requests based on the ordering information and the plurality of sub-order requests will be sent to a plurality of vehicle-mounted terminals. The apparatus may also not divide the first order request, but adjust the order of the plurality of destination addresses according to the preset condition, which reduces the cost of booking a vehicle. Compared with the comparison embodiment, when the user wants to go to a plurality of destination addresses, the apparatus may divide the first order request into a plurality of sub-order requests when it is confirmed that the first order request needs to be divided. In this way, there is no necessity for the user to temporarily direct a way for the driver for each destination address or to determine the driving route based on experience of the driver, which improves reliability of booking a vehicle, and improves the user experience of hailing a taxi.

In view of above, in the order processing apparatus provided by the embodiment of the present disclosure, the apparatus may receive a first order request sent by a user terminal and process the first order request to obtain a second order request, and then send the second order request to at least one vehicle-mounted terminal, wherein the first order request includes ordering information including a plurality of destination addresses. Compared with the comparison embodiment, the apparatus is adapted to case where the ordering information includes a plurality of destination addresses. Through the apparatus, the user may still successfully book a vehicle even when inputting a plurality of destination addresses, which improves reliability of booking a vehicle, improves the user experience of hailing a taxi, and reduces the cost of booking a vehicle.

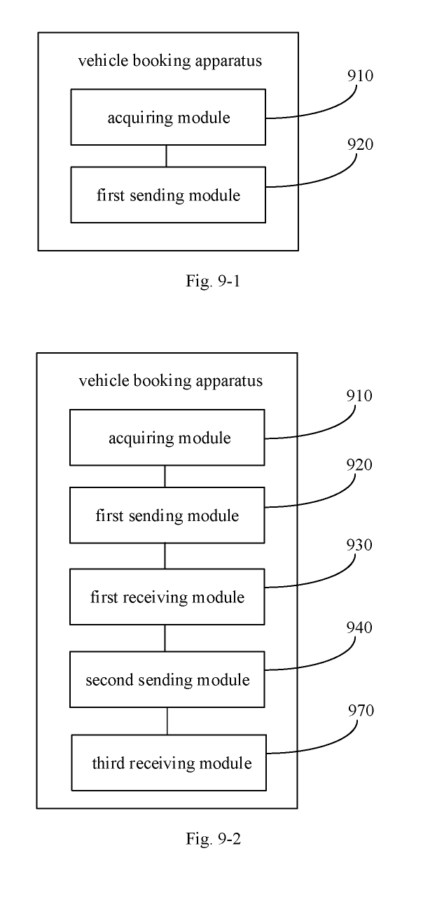

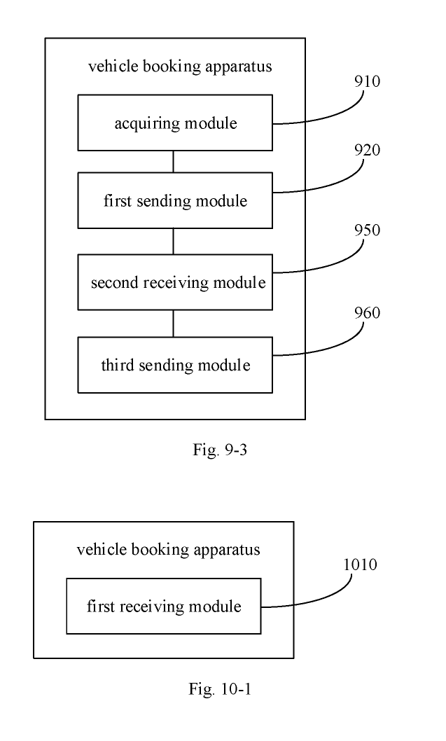

FIG. 9-1 is a block diagram of a vehicle booking apparatus according to an exemplary embodiment. The vehicle booking apparatus may be implemented as part or all of a user terminal by software, hardware, or a combination thereof. The vehicle booking apparatus may include:

an acquiring module 910, configured to acquire a first order request, the first order request including ordering information, the ordering information at least including n destination addresses, n≧2 and the n being an integer; and

a first sending module 920, configured to send the first order request to a taxi server, such that the taxi server processes the first order request according to the n destination addresses, to obtain a second order request, and sends the second order request to at least one vehicle-mounted terminal.

In view of above, in the order processing apparatus provided by the embodiment of the present disclosure, the apparatus may send a first order request to a taxi server, such that the taxi server may process the first order request according to the plurality of destination addresses of the ordering information included in the first order request, to obtain a second order request, and send the second order request to at least one vehicle-mounted terminal. Compared with the comparison embodiment, the apparatus is applicable to the case where the ordering information includes a plurality of destination addresses. Through the apparatus, the user may still book a vehicle successfully even when inputting a plurality of destination addresses, thus improving the reliability of booking a vehicle.

Optionally, the second order request is m sub-order requests, 2≦m≦n and the m being an integer. As shown in FIG. 9-2, the apparatus further includes:

a first receiving module 930, configured to receive a dividing request sent by the taxi server, the dividing request including m sub-order requests, m, or dividing prompt information; and

a second sending module 940, configured to send a response of confirming dividing to the taxi server.

Optionally, the ordering information further includes an address type identification for indicating that the n destination addresses are n serial destination addresses that a user expects to reach successively, and the ordering information further includes a stay time of the user being at a first destination address, the first destination address being any one of the n destination addresses except for a last destination address.

Optionally, the ordering information further includes a start address and an address type identification, the address type identification being used to indicate that the n destination addresses are n parallel destination addresses that a user expects to reach.

Optionally, the ordering information further includes user information including an identification of a target user and a telecommunication number of the target user. Each of the sub-order request includes the start address, the n destination addresses, the identification of the target user and the telecommunication number of the target user. Optionally, the user information further includes an identification of the target user, and each sub-order request further includes the identification of the target user.

Optionally, the ordering information further includes a start address and user information. The user information includes telecommunication numbers of n users and an address number correspondence relationship, the address number correspondence relationship being used to record a correspondence relationship between a destination address and a telecommunication number of a user, the n users including a target user, each of the sub-order requests includes the start address, one of the n destination addresses, and a telecommunication number of a user corresponding to one of the n destination addresses. Optionally, the user information further includes an identification of the target user, and each sub-order request further includes the identification of the target user.

Further, as shown in FIG. 9-3, the apparatus further includes:

a second receiving module 950, configured to receive a dividing request sent by the taxi server, the dividing request including at least two sets of dividing requests, the at least two sets of dividing requests being obtained by the taxi server dividing the first order request through at least two dividing manners, each set of the dividing requests including: m sub-order requests to be selected; and

a third sending module 960, configured to send a response of confirming dividing to the taxi server, such that the taxi server determines the m sub-order requests to be selected in the target dividing request as the m sub-order requests, the response including a set of target dividing requests confirmed by the user terminal in the at least two sets of dividing requests.

As shown in FIG. 9-2, the apparatus further includes:

a third receiving module 970, configured to receive a sub-order request response sent by the taxi server for each sub-order request, the sub-order request response being sent to the taxi server by the vehicle-mounted terminal, the sub-order request response including vehicle information and driver information corresponding to the vehicle-mounted terminal.

Specifically, the acquiring module 910 is configured to:

receive input information of the user, the input information including n destination addresses; and

generate a first order request based on the input information.

In view of above, in the order processing apparatus provided by the embodiment of the present disclosure, the apparatus may send a first order request to a taxi server, such that the taxi server processes the first order request according to the plurality of destination addresses of the ordering information included in the first order request, to obtain a second order request, and sends the second order request to at least one vehicle-mounted terminal. Compared with the comparison embodiment, the apparatus is applicable to the case where the ordering information includes a plurality of destination addresses. Through the apparatus, the user may still book a vehicle successfully even when inputting a plurality of destination addresses, thus improving the reliability of booking a vehicle, improving the user experience of hailing a taxi, and reducing the cost of booking a vehicle.

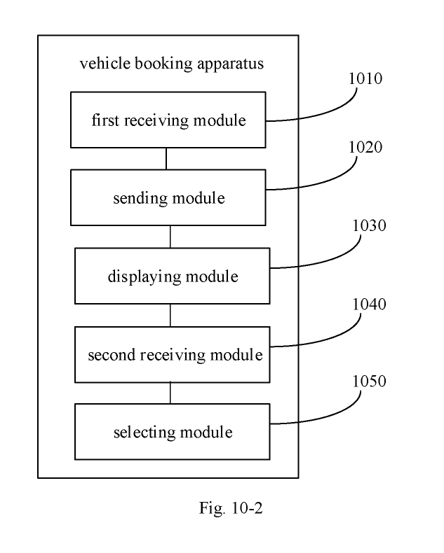

FIG. 10-1 is a block diagram of a vehicle booking apparatus according to an exemplary embodiment. The vehicle booking apparatus may be implemented as part or all of a vehicle-mounted terminal by software, hardware, or a combination thereof. The vehicle booking apparatus may include:

a first receiving module 1010, configured to receive a second order request sent from the taxi server, wherein the second order request is obtained by the taxi server processing the first order request based on the n destination addresses. The first order request includes ordering information, the ordering information at least including n destination addresses, n≧2 and the n being an integer.

In view of above, in the order processing apparatus provided by the embodiment of the present disclosure, the apparatus may receive a second order request sent from the taxi server. The second order request is obtained by the taxi server processing the first order request based on the plurality of destination addresses of the ordering information included in the first order request. Compared with the comparison embodiment, the apparatus is applicable to the case where the ordering information includes a plurality of destination addresses. Through the apparatus, the user may still book a vehicle successfully even when inputting a plurality of destination addresses, thus improving the reliability of booking a vehicle.

Optionally, the second order request is m sub-order requests, 2≦m≦n and the m being an integer. As shown in FIG. 10-2, the apparatus further includes:

a sending module 1020, configured to send a sub-order request response to the taxi server, such that the taxi server sends the sub-order request response to a user terminal, the sub-order request response including vehicle information and driver information corresponding to the vehicle-mounted terminal.

Further, the ordering information further includes a start address, user information and an address type identification, the address type identification being used to indicate that the n destination addresses are n parallel destination addresses that a user expects to reach. The user information includes a telecommunication number of a target user. Each of the sub-order request includes the start address, the n destination addresses and the telecommunication number of the target user.

As shown in FIG. 10-2, the apparatus further includes:

a displaying module 1030, configured to display n destination addresses;

a second receiving module 1040, configured to receive a selection instruction for instructing to select one from the n destination addresses to serve as an end point; and

a selecting module 1050, configured to select one from the n destination addresses as an end point according to the selection instruction.

Optionally, the user information further includes an identification of the target user, and each sub-order request further includes the identification of the target user.

The meaning of other reference numerals in FIG. 10-2 may refer to FIG. 10-1.

In view of above, in the order processing apparatus provided by the embodiment of the present disclosure, the apparatus may receive a second order request sent from the taxi server. The second order request is obtained by the taxi server processing the first order request based on the plurality of destination addresses of the ordering information included in the first order request. Compared with the comparison embodiment, the apparatus is applicable to the case where the ordering information includes a plurality of destination addresses. Through the apparatus, the user may still book a vehicle successfully even when inputting a plurality of destination addresses, thus improving the reliability of booking a vehicle, improving the user experience of hailing a taxi, and reducing the cost of booking a vehicle.

The embodiment of the present embodiment further provides a vehicle booking system including: a taxi server, a user terminal, and a vehicle-mounted terminal.

In the embodiment, the taxi server includes the vehicle booking apparatus as shown in FIG. 8-1 or FIG. 8-4.

The user terminal includes the vehicle booking apparatus as shown in FIG. 9-1, 9-2 or 9-3.

The vehicle-mounted terminal includes the vehicle booking apparatus as shown in FIG. 10-1 or FIG. 10-2.

In view of above, in the order processing system provided by the embodiment of the present disclosure, a taxi server may receive a first order request sent from a user terminal, and process the first order request to obtain a second order request, and then send the second order request to at least one vehicle-mounted terminal. In the embodiment, the first order request includes ordering information, and the ordering information includes a plurality of destination addresses. Compared with the comparison embodiment, the system is applicable to the case where the ordering information includes a plurality of destination addresses. Through the system, the user may still book a vehicle successfully even when inputting a plurality of destination addresses, thus improving the reliability of booking a vehicle, improving the user experience of hailing a taxi, and reducing the cost of booking a vehicle.

It will be apparent to those skilled in the art that, for convenience and simplicity of the description, the specific operation process of the system, apparatus and module described above may refer to the corresponding process in the foregoing method embodiments, which will not be repeated herein.

It will be understood by those skilled in the art that, all or part of the steps of implementing the embodiments described above may be accomplished by hardware, or by means of instructions to instruct the associated hardware to be accomplished. The programs may be stored in a computer readable storage medium. The above-mentioned storage medium may be read-only memory, a magnetic disk, or an optical disk.

The foregoing is merely a preferred embodiment of the present disclosure and is not intended to limit the present disclosure. Any modifications, equivalent substitutions, improvements and the like within the spirit and principle of the present disclosure are intended to be encompassed by the protection scope of the present disclosure.

What is claimed is:

1. An order processing method, comprising:
receiving a first order request, the first order request comprising ordering information, the ordering information at least comprising n destination addresses, n≧2 and the n being an integer;
processing the first order request according to the n destination addresses, to obtain a second order request; and
sending the second order request to a vehicle-mounted terminal.

2. The method of claim 1, wherein the step of processing the first order request according to the n destination addresses to obtain a second order request comprises:
judging whether the first order request needs to be divided according to the ordering information; and when the first order request needs to be divided, dividing the first order request into m sub-order requests according to the ordering information, 2≦m≦n and the m being an integer; and
taking the m sub-order requests as the second order request,
wherein the step of sending the second order request to at least one vehicle-mounted terminal comprises:
sending the m sub-order requests to at least m different vehicle-mounted terminals respectively.

3. The method of claim 2, wherein before the m sub-order requests are sent to at least m different vehicle-mounted terminals respectively, the method further comprises:
sending a dividing request to a user terminal, the dividing request comprising the m sub-order requests; and
receiving a response of confirming dividing sent by the user terminal.

4. The method of claim 2, wherein the ordering information further comprises a first address type identification for indicating that the n destination addresses are n serial destination addresses, and the ordering information further comprises a stay time of the user being at a first destination address, the first destination address being any one of the n destination addresses except for a last destination address,
wherein the step of judging whether the first order request needs to be divided according to the ordering information comprises:
judging whether the first destination address meets a first preset condition; and
when the first destination address meets the first preset condition, determining that the first order request needs to be divided,
wherein the step of dividing the first order request into m sub-order requests according to the ordering information comprises:
dividing the first order request into a first sub-order request and a second sub-order request with the first destination address as a demarcation point, an end point in the first sub-order request being the first destination address, and a start point of the second sub-order request being the first destination address, wherein the first preset condition is:
t₁>a*t₂;
wherein the t₁ is the stay time of the user being at the first destination address, the t₂ is a driving time from the first destination address to a second destination address, the second destination address being a next destination address adjacent to the first destination address, the a being greater than 0 and less than 1.

5. The method of claim 4, wherein the step of sending the m sub-order requests to at least m different vehicle-mounted terminals respectively comprises:
sending the first sub-order request to at least one first vehicle-mounted terminal; and
after it is determined that the user has reached the first destination address and a preset time period has elapsed, sending the second sub-order request to at least one second vehicle-mounted terminal, the preset time period being less than or equal to the t₁.

6. The method of claim 5, wherein the step of ordering information further comprises a start address, and before judging whether the first order request needs to be divided according to the ordering information, the method further comprises:
judging whether n+1 addresses consisting of the start address and the n destination addresses meet a second preset condition; and
when the n+1 addresses meet the second preset condition, adjusting an order of the n serial destination addresses,
wherein the second preset condition is:
S₁>S₃;
or, T₁>T₃;
or, S₁>S₃ and T₁>T₃;
wherein the S₁ is a sum of driving distances of adjacent two addresses of the n+1 addresses, the S₃ is a sum of driving distances of adjacent two addresses of the n+1 addresses whose order has been adjusted, the T₁ is a sum of driving times of adjacent two addresses of the n+1 addresses, and the T₃ is a sum of driving times of adjacent two addresses of the n+1 addresses whose order has been adjusted.

7. The method of claim 2, wherein the step of ordering information further comprises a start address and a second address type identification, the second address type identification being used to indicate that the n destination addresses are n parallel destination addresses that a user expects to reach,
wherein the step of judging whether the first order request needs to be divided according to the ordering information comprises:
judging whether n+1 addresses consisting of the start address and the n destination addresses meet a third preset condition; and
when the n+1 addresses meet the third preset condition, determining that the first order request needs to be divided,
wherein the step of dividing the first order request into m sub-order requests according to the ordering information comprises:
dividing the first order request into m sub-order requests according to the ordering information, the m being equal to the n, a start point in each of the sub-order requests being the start address, and an end point in each of the sub-order requests being one of the n destination addresses,
wherein the third preset condition is:
S₁>S₂;
or, T₁>T₂;
or, S₁>S₂ and T₁>T₂;
wherein the S₁ is a sum of driving distances of adjacent two addresses of the n+1 addresses, the S₂ is a sum of driving distances from the start address to each of the n destination addresses, the T₁ is a sum of driving times of adjacent two addresses of the n+1 addresses, and the T₂ is a sum of driving times from the start address to each of the n destination addresses.

8. The method according to claim 7, wherein the step of ordering information further comprises user information comprising a telecommunication number of a target user,
each of the sub-order request comprises the start address, the n destination addresses and the telecommunication number of the target user,
the ordering information further comprises user information comprising telecommunication numbers of n users and an address number correspondence relationship, the address number correspondence relationship being used to record a correspondence relationship between a destination address and a telecommunication number of a user, the n users comprising target users, and
each of the sub-order requests comprises the start address, one of the n destination addresses, and a telecommunication number of a user corresponding to one of the n destination addresses.

9. The method of claim 2, wherein the step of dividing the first order request into m sub-order requests according to the ordering information comprises:
dividing the first order request according to the ordering information to obtain at least two sets of dividing requests through at least two dividing manners, each set of the dividing requests comprising: m sub-order requests to be selected, the at least two dividing manners comprising a serial dividing manner and a parallel dividing manner;
sending a dividing request to the user terminal, the dividing request comprising the at least two sets of dividing requests corresponding to different dividing manners;
receiving a response of confirming dividing sent from the user terminal, the response comprising a set of target dividing requests confirmed by the user terminal in the at least two sets of dividing requests; and
determining the m sub-order requests to be selected in the target dividing request as the m sub-order requests.

10. The method of claim 2, wherein after the m sub-order requests are sent to at least m different vehicle-mounted terminals respectively, the method further comprises:
receiving a sub-order request response sent by the at least m different vehicle-mounted terminals respectively, the sub-order request response comprising vehicle information and driver information corresponding to a vehicle-mounted terminal;
selecting m sub-order request responses from the at least m sub-order request responses; and
sending the m sub-order request responses to the user terminal.

11. The method of claim 1, wherein the step of ordering information further comprises an address type identification and a start address, the address type identification is used to indicate that the n destination addresses are n serial destination addresses that a user expects to reach successively,
wherein the step of processing the first order request according to the n destination addresses to obtain a second order request comprises:
judging whether n+1 addresses consisting of the start address and the n destination addresses meet a second preset condition;
when the n+1 addresses meet the second preset condition, adjusting an order of the n serial destination addresses and obtaining the second order request,
wherein the second preset condition is:
S₁>S₃;
or, T₁>T₃;
or, S₁>S₃ and T₁>T₃;
wherein the S₁ is a sum of driving distances of adjacent two addresses of the n+1 addresses, the S₃ is a sum of driving distances of adjacent two addresses of the n+1 addresses whose order has been adjusted, the T₁ is a sum of driving times of adjacent two addresses of the n+1 addresses, and the T₃ is a sum of driving times of adjacent two addresses of the n+1 addresses whose order has been adjusted.

12. An order processing apparatus, comprising:
a processor; and
a memory, for storing instructions executable by the processor,
wherein the processor is configured to:
receive a first order request, the first order request comprising ordering information, the ordering information at least comprising n destination addresses, n≧2 and the n being an integer;
process the first order request according to the n destination addresses, to obtain a second order request; and
send the second order request to a vehicle-mounted terminal.

13. The apparatus of claim 12, wherein the processing the first order request according to the n destination addresses to obtain a second order request comprises:
judging whether the first order request needs to be divided according to the ordering information; and when the first order request needs to be divided, dividing the first order request into m sub-order requests according to the ordering information, 2≦m≦n and the m being an integer; and
taking the m sub-order requests as the second order request,
wherein the sending the second order request to at least one vehicle-mounted terminal comprises:
sending the m sub-order requests to at least m different vehicle-mounted terminals respectively.

14. The apparatus of claim 13, wherein the ordering information further comprises a first address type identification for indicating that the n destination addresses are n serial destination addresses, and the ordering information further comprises a stay time of the user being at a first destination address, the first destination address being any one of the n destination addresses except for a last destination address,
wherein the judging whether the first order request needs to be divided according to the ordering information comprises:
judging whether the first destination address meets a first preset condition; and
when the first destination address meets the first preset condition, determining that the first order request needs to be divided,
wherein the dividing the first order request into m sub-order requests according to the ordering information comprises:
dividing the first order request into a first sub-order request and a second sub-order request with the first destination address as a demarcation point, an end point in the first sub-order request being the first destination address, and a start point of the second sub-order request being the first destination address,
wherein the first preset condition is:
t₁>a*t₂;
wherein the t₁ is the stay time of the user being at the first destination address, the t₂ is a driving time from the first destination address to a second destination address, the second destination address being a next destination address adjacent to the first destination address, the a being greater than 0 and less than 1.

15. The apparatus of claim 14, wherein the sending them sub-order requests to at least m different vehicle-mounted terminals respectively comprises:
sending the first sub-order request to at least one first vehicle-mounted terminal; and
after it is determined that the user has reached the first destination address and a preset time period has elapsed, sending the second sub-order request to at least one second vehicle-mounted terminal, the preset time period being less than or equal to the t₁.

16. The apparatus of claim 15, wherein the ordering information further comprises a start address, before judging whether the first order request needs to be divided according to the ordering information, the processor is further configured to:
judge whether n+1 addresses consisting of the start address and the n destination addresses meet a second preset condition; and
when the n+1 addresses meet the second preset condition, adjust an order of the n serial destination addresses, wherein the second preset condition is:
S₁>S₃;
or, T₁>T₃;
or, S₁>S₃ and T₁>T₃;
wherein the S₁ is a sum of driving distances of adjacent two addresses of the n+1 addresses, the S₃ is a sum of driving distances of adjacent two addresses of the n+1 addresses whose order has been adjusted, the T₁ is a sum of driving times of adjacent two addresses of the n+1 addresses, and the T₃ is a sum of driving times of adjacent two addresses of the n+1 addresses whose order has been adjusted.

17. The apparatus of claim 13, wherein the ordering information further comprises a start address and a second address type identification, the second address type identification being used to indicate that the n destination addresses are n parallel destination addresses that a user expects to reach,
wherein the judging whether the first order request needs to be divided according to the ordering information comprises:
judging whether n+1 addresses consisting of the start address and the n destination addresses meet a third preset condition; and
when the n+1 addresses meet the third preset condition, determining that the first order request needs to be divided,
wherein the dividing the first order request into m sub-order requests according to the ordering information comprises:
dividing the first order request into m sub-order requests according to the ordering information, the m being equal to the n, a start point in each of the sub-order requests being the start address, and an end point in each of the sub-order requests being one of the n destination addresses,
wherein the third preset condition is:
S₁>S₂;
or, T₁>T₂;
or, S₁>S₂ and T₁>T₂;
wherein the S₁ is a sum of driving distances of adjacent two addresses of the n+1 addresses, the S₂ is a sum of driving distances from the start address to each of the n destination addresses, the T₁ is a sum of driving times of adjacent two addresses of the n+1 addresses, and the T₂ is a sum of driving times from the start address to each of the n destination addresses.

18. The apparatus according to claim 17, wherein the ordering information further comprises user information comprising a telecommunication number of a target user,
each of the sub-order request comprises the start address, the n destination addresses and the telecommunication number of the target user,
the ordering information further comprises user information comprising telecommunication numbers of n users and an address number correspondence relationship, the address number correspondence relationship being used to record a correspondence relationship between a destination address and a telecommunication number of a user, the n users comprising a target user, and
each of the sub-order requests comprises the start address, one of the n destination addresses, and a telecommunication number of a user corresponding to one of the n destination addresses.

19. The apparatus of claim 14, wherein the dividing the first order request into m sub-order requests according to the ordering information comprises:
dividing the first order request according to the ordering information to obtain at least two sets of dividing requests through at least two dividing manners, each set of the dividing requests comprising: m sub-order requests to be selected, the at least two dividing manners comprising a serial dividing manner and a parallel dividing manner;
sending a dividing request to the user terminal, the dividing request comprising the at least two sets of dividing requests corresponding to different dividing manners;
receiving a response of confirming dividing sent from the user terminal, the response comprising a set of target dividing requests confirmed by the user terminal in the at least two sets of dividing requests; and
determining the m sub-order requests to be selected in the target dividing request as the m sub-order requests.

20. An order processing system, comprising: a server, a user terminal and a vehicle-mounted terminal,
wherein the server is configured to: receive a first order request, the first order request comprising ordering information, the ordering information at least comprising n destination addresses, n≧2 and the n being an integer; process the first order request according to the n destination addresses, to obtain a second order request; and send the second order request to a vehicle-mounted terminal;
the user terminal is configured to: acquire a first order request, the first order request comprising ordering information, the ordering information at least comprising n destination addresses, n≧2 and the n being an integer; and
send the first order request to a taxi server, such that the taxi server processes the first order request according to the n destination addresses to obtain a second order request and sends the second order request to the vehicle-mounted terminal.
